(19) United States
(12) Patent Application Publication
(10) Pub. No.: US 2012/0096145 A1
(43) Pub. Date: Apr. 19, 2012

(54) MULTI-TIER INTEGRATED SECURITY SYSTEM AND METHOD TO ENHANCE LAWFUL DATA INTERCEPTION AND RESOURCE ALLOCATION

(75) Inventors: Robert D. Le, Milpitas, CA (US); Timothy Bean, Pleasanton, CA (US); Leonti S. Dailis, Shelton, CT (US); Cemal Tamer Dikmen, Trumbull, CT (US); Bulent Erbilgin, Cupertino, CA (US); Martin Tomas C. Guerrero, Santa Clara, CA (US); Henry D. Huang, Los Altos, CA (US); Kevin McTiernan, Castro Valley, CA (US); Martin W. Rosera, Los Gatos, CA (US)

(73) Assignee: SS8 NETWORKS, INC., Milpitas, CA (US)

(21) Appl. No.: 13/022,627

(22) Filed: Feb. 7, 2011

Related U.S. Application Data
(60) Provisional application No. 61/388,605, filed on Dec. 22, 2010.
(60) Provisional application No. 61/389,192, filed on Oct. 1, 2010.

(51) Int. Cl. G06F 15/173

(52) U.S. Cl. 709/224

(57) ABSTRACT

A system, method, and apparatus for intercepting data streams such as packets on a network. In one embodiment, the method includes: receiving at a network surveillance system (NSS), a target to be intercepted on the network; creating a target identification (target ID) for the target, wherein the target ID is unique to the NSS in order to track data streams of the target during subsequent processing, such as extraction of content and metadata, in the NSS; intercepting the data streams of the target on the network; tagging the data streams of the target that are intercepted from the network with a respective target ID; transmitting the data streams of the target to the NSS for subsequent analysis; and distributing the data streams across a scalable quantity of data processing engines in the NSS.

### CROSS-REFERENCE TO RELATED APPLICATIONS

This application claims priority to provisional applications: Ser. No. 61/388,605 filed Sep. 30, 2010; and Ser. No. 61/389,192 filed Oct. 1, 2010, both entitled: “Multi-Tier Integrated Security System and Method To Enhance Lawful Data Interception and Resource Allocation,” which applications are also incorporated by reference herein in their entirety.

### FIELD OF TECHNOLOGY

This disclosure relates generally to the technical fields of network communication, and in one example embodiment, this disclosure relates to a method, apparatus and system of interception of data on a network.

### BACKGROUND

Governments and agencies monitor, surveil, intercept and analyze communication network data primarily for regulation and security purposes. Communications can take many forms including; circuit switched phone systems; wireless telecom systems; and packet switched data, voice, and video on networks and the Internet. Legislation in the United States has been promulgated to regulate such activities and qualify them as lawful interception (LI) under the Communications Assistance for Law Enforcement Act (CALEA) for use by Law Enforcement Agencies (LEA). Compliance with the requirements of LI is important in order to avoid violations and penalties. Private actions of surveillance can be performed as well, for example, on a private Local Area Network (LAN).

Similarly, businesses and non-government analysts seek content and metadata communicated between users on a wide variety of communication systems and formats. This information can be useful for determining commercial, investment, and personal information and relationships.

Intercept systems and architecture utilize hardware and software solutions that are segregated into three primary functional groups, or stages, called: access, mediation, and collection. Some protocols substitute the term ‘collection’ for ‘access’ and ‘delivery’ for ‘collection’ but they will not be used herein. The term ‘access’ refers to the function of literally accessing data from a network via either an active intercept or a passive intercept. Active intercept leverages existing network elements such as switches, routers, gateways, etc., to copy and forward desired information. That is, the active intercept utilizes built-in interfaces and ports in network equipment, such as routers, to access the desired data, which is then communicated to mediation equipment within the intercept system. When active intercepts are unavailable or undesirable, then a passive intercept can be utilized. A passive intercept inductively accesses data on the network, e.g., via a probe that sits on the communication line and reads the data as it streams through the link. Thereafter, the data is similarly communicated to mediation equipment.

Typically, target communications are sought on the network by various government agencies or by authorized individuals with access to the intercept system. A target refers to a specific person or entity communicating on a specific medium and format that is either: authorized by a warrant; or is a person of interest (POI) in jurisdictions where a warrant is not mandatory. For example, a target might be: any communication involving John Doe (as sender or recipient) communicating via email on the Internet at any time during the day into or out of a given jurisdiction; or any communication involving Jane Doe (as sender or recipient) via voice over internet protocol (VOIP) over the Internet between midnight and 6 am. The types, description, and details of the targets and intercept details are virtually unlimited. An entity can be either any collection of persons or other entities, e.g., a corporation, a syndicate, a conspiratorial network, a gang, etc.

Mediation refers to the hardware and software solutions that provide the function of literally ‘mediating’ between a user of the intercept system and the intercept system itself with its access function and collection function of data.

The collection function refers to the hardware and software solutions that further organize, analyze, and provide the data to a user, such as a LEA, and that interact with the user, typically via a graphical user interface (GUI), to locate and identify meaningful data The type of data communicated on the network is typically broken down into two parts: content and metadata. Metadata refers to data describing details associated with the content. For example, metadata from an IP packet would include source and destination IP address, version, length, options, padding, error correction information, identification, flags, protocol information, subject line, document attachment information, routing information, proxy server information, etc. The content is the actual substantive data to be communicated, e.g., a conversation or data record in text, voice, video, etc.

### SUMMARY

A method for intercepting data streams, such as data packets, on a network, such as the Internet, is disclosed. Features include: 1) autoprovisioning; 2) packet management via target ID; 3) scalable mediation; 4) multi-path processing of intercepted data; 5) multi-tenant capability on a single surveillance system; 6) multi-network capability on a single surveillance; 7) retained data recovery; and 8) scalable mediation.

In one embodiment, the method includes: receiving at a network surveillance system (NSS), such as a lawful interception (LI) surveillance network, a target to be intercepted on the network; creating a target identification (target ID) for the target, wherein the target ID is unique to the NSS in order to track data streams of the target during subsequent processing, such as extraction of content and metadata, in the NSS; provisioning a list of target IDs via a data mediation engine to an access device in order to intercept data streams used by the targets on the network; provisioning at least one access device coupled to the network to intercept the data streams used by the targets, wherein the access device is a passive probe or is an active port to a network router; intercepting the data streams of the target on the network; tagging the data streams of the target that are intercepted from the network with a respective target ID; and transmitting the data streams of the target to the NSS for subsequent analysis. The process of receiving a target and creating a target ID can be repeated for a plurality of targets, followed by: aggregating the targets received at the NSS to determine a superset of data streams to be intercepted prior to provisioning to an access device and subsequent steps.

In one embodiment of the NSS, a first data path the subsequent analysis of data streams of the target intercepted on the network including: distributing the data streams across a scalable quantity of data processing engines, such as data processing units (DPUs) and data storage units (DSUs), in the NSS; evaluating a metadata portion of the data streams using a scalable quantity of DPUs; storing a content portion of the data streams in a scalable quantity of data storage units DSUs coupled to the DPUs; receiving data from the scalable quantity of data processing engines, e.g., DPUs and DSUs, at a server; and transferring the data to an analysis system for interpreting the data.

The target ID is unique for a combination of information chosen from a set of data including, but not limited to: the target, e.g., a target name, phone number, handle, etc; a target type associated with the target; relational data associated with the target such as a network provider ID, an intercept time and an intercept date, network ID, etc. By using a look up table (LUT) or other relational system to track the target and the data streams of the target, the data stream can be processed agnostically by the network surveillance system hardware.

In another embodiment of the NSS, a parallel and optional second data path analyzes a metadata portion of at least one of the data streams, or any portion, including all, of the data streams of targets and/or non-targets on the network, and evaluates them using a metadata processing engine in the NSS. The evaluation analyzes relational data between a metadata portion of a plurality of data streams from a plurality of network users in order to identify a relationship between at least two of the plurality of data streams, e.g., a relationship between multiple targets, multiple non-targets, or a target and a non-target, and thereby optionally identify an advanced target to intercept. Thus, if the metadata of a target's data stream and a non-target's data stream identify a relationship, e.g., a common subject reference, a meeting location, a same attachment to an email, etc., then the non-target can be provisioned as an advanced target to be intercepted on the network based upon the relationship discovered by the metadata processing unit. At that point, an interface manager can receive the advanced target, evaluate the advanced target for redundancy against existing targets of the NSS; and then communicate the advanced target to at least one access device to intercept data streams associated with the advanced target, e.g., either from the network or from a circular storage device.

In yet another embodiment of the NSS, a parallel and optional third data path function, stores either a portion of or all of, e.g., content and metadata, the data streams intercepted from the network, for targets and/or non-targets in a circular storage device, such as a circular buffer, for future access. This provides a look-back provision to recover data that only becomes authorized or needed after it has completed transmission on the network and may no longer be interceptable.

An analysis system portion of the NSS receives a variety of data for targets, advanced targets, and non-targets, including content and metadata, and other relational data there between from any combination of the first, second, and third data path for further processing methods including: evaluating relational data between a plurality of network users of the data streams to identify a relationship and a degree of freedom, e.g., a degree of separation, between a plurality of network users; and displaying on an analysis GUI, the data and relationships of the intercepted data from the network. The analysis GUI is operable to receive commands from an analysis user in order to intercept additional data, query the system, or add notes or other analysis user-defined metadata regarding a target or non-target.

The methods, apparatus, and system herein can act as a single source to manage targets and non-targets, and their intercepted data for a plurality of surveillance users, e.g., LEAs, or multi-tenants. This is accomplished by tracking and controlling access to targets, non-targets and their data vis-à-vis a surveillance user ID to one or more target IDs, where the surveillance ID specifies the administrative rights and privileges the surveillance user has on the NSS, e.g., access to the targets they entered into the NSS or the targets to which they have authority to access. Thus, the present disclosure allows a single NSS to manage multiple independent surveillance users, or LEAs, while still maintaining strict security and confidentiality for each of the surveillance users. By not requiring a separate surveillance system for each surveillance user, substantial savings in cost and other resources can be realized. Note that a surveillance user is typically an entity that enters targeting information into the NSS while an analysis user is typically an entity that analyzes the collection and analysis results of the NSS, though a single entity can function as both types of users. With autoprovisioning, the NSS can act as the entity that automatically enters the advanced target information back into the NSS.

Similarly, the methods, apparatus, and system herein can act as a single source to manage targets and non-targets, and their intercepted data on a plurality of networks, e.g., multi-network. This is accomplished by tracking and controlling access to targets, non-targets and their data vis-à-vis a network ID to one or more target IDs, where the network ID can specify features such as data link types, individual network protocols, rules, and other requirements. Thus, the present disclosure allows a single NSS to manage multiple independent networks, can be realized while still maintaining strict security and confidentiality and compliance on a network by network basis. By not requiring a separate surveillance system for each network, substantial savings in cost and other resources can be realized.

In another embodiment, a network surveillance system is disclosed, which comprises: a graphical user interface (GUI) to receive a target to be intercepted on a network; a data mediation engine coupled to the GUI, the mediation engine operative to create a target ID for the target in the network, wherein the target ID is unique to the network surveillance system (NSS) in order to track data streams of the target in subsequent processing by the NSS; and an access device, coupled to the mediation engine, for intercepting the data streams of the target on the network.

The data mediation engine, or simply mediation engine, on the back end is operable to: receive a list of targets from the GUI; and provision the list of targets to the access device in order to intercept data streams used by the targets.

The access device used to intercept data streams from the network can be a passive device, e.g., a probe, coupled to a communication link, e.g., a wired trunk cable, to passively intercept data streams, or it can be an access point to actively intercept information from a network device, e.g., a router, gateway, switch, etc. A plurality of access devices can be coupled to at least one network, e.g., a single network, or can be distributed across a plurality of networks. The access device is operable to tag the data streams of the target with a respective target ID, by inserting the target ID value in a header of the data stream. Similarly, the access device is operable to tag the data streams of the non-targets with a respective record ID that is different and unique from a target ID, by inserting the record ID value in a header of the data stream. The target ID and record ID values can be fitted into either an existing header of the data stream by displacing existing information in the header or by adding a new header to the packet and inserting the target ID or record ID thereto. The data can then proceed to at least one of three paths: a) to a line card for transmission to the data mediation engine (first data path); b) to a metadata mediation engine (second data path); via a server, coupled to the access device, and c) to a circular storage device, coupled to the access device, for storing at least a portion of the data streams intercepted from the network for future surveillance analysis (third data path).

For the first data path, the data, or target, mediation engine on the front end comprises a scalable quantity of data processing engines for evaluating data streams intercepted from a network, wherein the scalable quantity of data processing engines allow the NSS to be scaled to accommodate higher data processing requirements, e.g., a higher quantity of data streams and/or a higher data rate. In particular, the scalable data processing engines include: a scalable quantity of data processing units (DPUs) for evaluating a metadata portion of the data streams; and a scalable quantity of data storage units (DSUs) coupled to the DPUs for short term storage of data. A scalable quantity of one or more load balancers is coupled to the scalable quantity of data processing engines, e.g., the DPUs and DSUs, to distribute the data streams across the data processing engines for subsequent processing.

The target mediation engine tracks the data streams via the target ID, thereby allowing the processing of data streams, or packets, within the NSS to be agnostic with regards to many system variables including: target ID, surveillance user ID, network ID, etc. that are managed in the NSS, e.g., via a look up table (LUT) or other data managing system, is used for cross-referencing the system variables. A given surveillance, or NSS, user will only have access, or visibility, to the data in the NSS which they have authority to access, e.g., targets they entered or to targets or other data to which they have authority to view, e.g., by an administrator. The agnostic processing allows for scalable architecture in the NSS.

The scalability is limited mostly by the chassis, slots therein, and other infrastructure hardware limitations. The system may be expanded quickly and easily by adding cards, additional chassis, and/or other networking links. This is a less expensive and a faster solution than upgrading a system that was designed as a proprietary or closed system, e.g., with more rigid limitations on bandwidth, tracking, and processing data streams therein, that would require a redesign of the entire system to accommodate higher quantity of traffic and/or data rate of traffic.

A server, e.g., a file transfer protocol (FTP) server, receives data from the mediation device and transfers the information to an analysis system operable to interpret the data. e.g., evaluate relational data between data streams of network users intercepted from the network in order to identify or establish a potential relationship and a degree of separation between the plurality of users; and output results to one or more analysis graphical user interfaces (GUIs). The analysis commands received back from a collection, or analysis, user via GUI for manipulation and retrieval of data. The analysis GUI is typically a separate and distinct GUI from the target input GUI, with higher security clearance going to the analysis GUI which sees much more sensitive information, e.g., collection and analysis information regarding targets, e.g., including advanced targets.

For the second data path, a metadata processing engine is coupled to the access device for evaluating a metadata portion of the data streams. The metadata processing engine is operable to: evaluate relational data between a metadata portion of the data streams from a plurality of users to identify a relationship between at least two of the plurality of users or their data streams; automatically request provisioning for an advanced target to be intercepted based upon the relationship discovered by the metadata processing engine (autoprovisioning); receive a request for provisioning the advanced target; provision the advanced target at the access device in order to intercept data streams used by the advanced target on the network; and intercept data streams associated with the advanced target from the network, e.g., an access device, and a circular storage device.

For the third data path, a circular buffer is coupled to, or within, the access device for saving any portion of data, e.g., metadata or content, for any portion of users of the network, e.g., targets and/or non-targets, into short-term storage.

Thus, the NSS can be a single source to manage intercepted data received from a plurality of access devices operating on a plurality of networks and for a plurality of surveillance users.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE VIEW OF DRAWINGS

Example embodiments are illustrated by way of example and not limitation in the figures of the accompanying drawings, in which like references indicate similar elements and in which:

FIG. 1 is a functional block diagram of a network security system, according to one or more embodiments.

FIG. 2 is an architecture layout of the network security system as applied to a plurality of networks, according to one or more embodiments.

FIG. 3 is a block diagram of an access device+mass metadata server+storage buffer engine of the network security system, for intercepting data on a network, according to one or more embodiments.

FIG. 4 is a block diagram of a metadata and advanced targeting engine portion of the network security system for evaluating a metadata portion of the network traffic, according to one or more embodiments.

FIG. 5 is a block diagram of a data mediation engine portion of the network security system for provisioning targets to be intercepted and for mediating intercepted data, according to one or more embodiments.

FIG. 6 is a block diagram of a collection and analysis engine portion of the network security system for analyzing and presenting intercepted data to the network security system user, according to one or more embodiments.

FIG. 7A is a case table illustrating data entry to data mediation engine and access function, showing several different possible combinations of intercept scenarios for targets and non-targets communicating on a network, according to one or more embodiments.

FIG. 7B is a case table illustrates functions of access and mediation, mass metadata processing, and circular buffer functions of data intercepted from targets and non-targets communicating on a network, according to one or more embodiments.

FIG. 7C is a case table illustrating collection and analysis of data provided by the network security system for GUI display, according to one or more embodiments.

FIG. 8A is a flowchart of a method for intercepting data streams on a network, according to one or more embodiments.

FIG. 8B is a flowchart, continued from FIG. 8A, of a method of mediating the intercepted target data, according to one or more embodiments.

FIG. 8C is a flowchart, continued from FIG. 8A, of a method of mass metadata extraction and analysis, according to one or more embodiments.

FIG. 8D is a flowchart, continued from FIG. 8A, of a method of storing and retrieving data on a circular buffer, according to one or more embodiments.

FIG. 8E is a flowchart, continued from FIG. 8B, 8C, or 8D, of a method of collecting and analyzing intercepted and processed data, according to one or more embodiments.

FIG. 9 is an illustration of partitioned memory for storing content, metadata, and analysis information for targets and non-targets, according to one or more embodiments.

Other features of the present embodiments will be apparent from the accompanying drawings and from the detailed description that follows.

### DETAILED DESCRIPTION

A method, apparatus and system of a hierarchy of a structure of a volume is disclosed. In the following description, for the purposes of explanation, numerous specific details are set forth in order to provide a thorough understanding of the various embodiments. It will be evident, however to one skilled in the art that various embodiments may be practiced without these specific details.

### Function Block Diagram

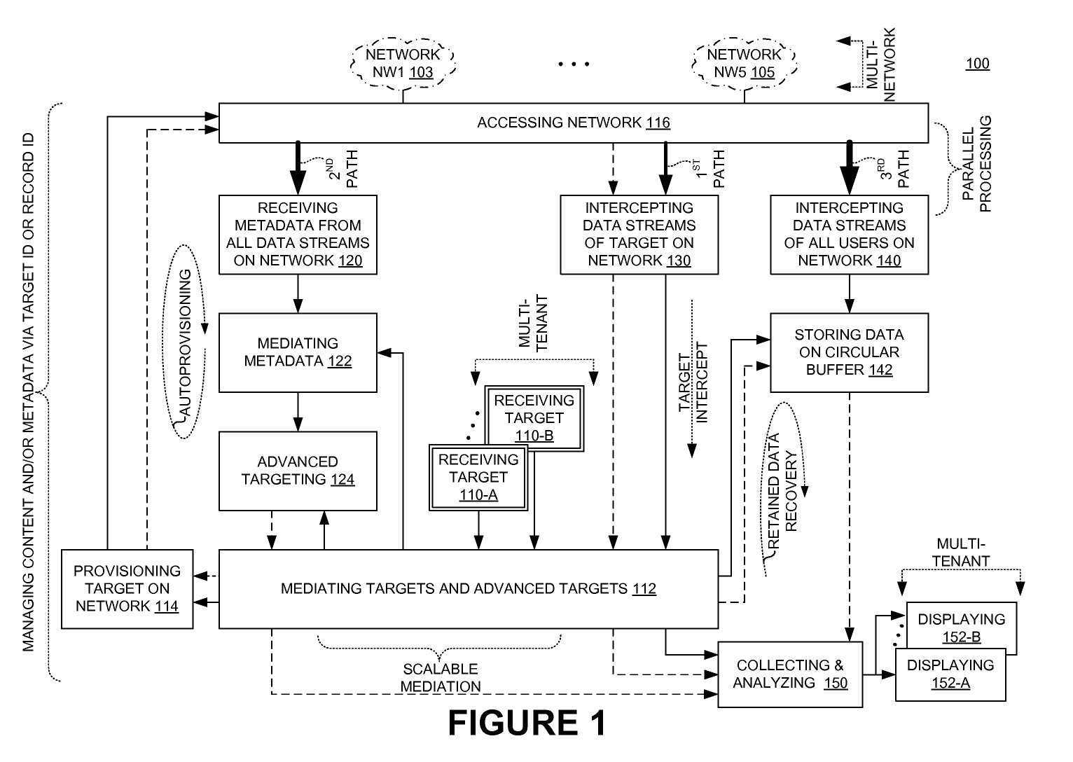

Referring now to FIG. 1, a functional block diagram 100 of a network surveillance system (NSS) is shown, according to one or more embodiments. The functions shown herein represent a high-level overview of the functionality of the network surveillance system to be implemented in hardware, software and methods that are described in subsequent figures. A starting function is target receiving block 110-A and optional target receiving block 110-B which act as an interface to receive target data from a network security system user, either manually or electronically, which is then passed to a target mediating function block 112 for mediating the target vis-à-vis rules and criteria for interception on the network as well as for resource allocation. The present disclosure provides for one NSS to receive target inputs from a plurality of NSS users, aka LEAs or tenants, e.g., via target input blocks 110-A and optional 110-B; hence it is referred to as multi-tenant capable. Once approved, target information, shown as a solid line, is passed to functional block 114 for provisioning an accessing function 116 to the appropriate networks, e.g., Network NW1 103 and NW5 105, which would then actually access and intercept data from the appropriate networks. The present disclosure provides for one NSS to access a plurality of networks with a single NSS system; hence it is referred to as multi-network capable.

Portions of data intercepted from the network by access functional block 116 are communicated parallely on multipaths to first, second, and third paths, or any combination thereof, then serially communicated down each multipath for subsequent processing and analysis. In particular, a first data path, or first path, couples accessing function 116 to intercepting function 130 that intercepts metadata and/or authorized or desired content, as jurisdictional rules provide, of data streams intercepted from the network for targets (shown as solid lines) and for advanced targets, (shown as dashed lines) and for optionally storing data. This intercepted data is communicated to: mediation block 112 for subsequent processing such as assembling data streams into communications, such that packets of fragmented data can be reconstructed into more meaningful and readable messages, and for temporarily storing them prior to communicating them to collecting and analyzing functional block 150; and subsequently displaying data and relationships to GUI functions 152-A and optional 152-B, for interacting by one or more network security system users.

A second data path includes an intercepting function 120 coupled to accessing function 116 that receives metadata, but essentially no content data, from any quantity of users of the network, including an option to intercept and communicate metadata to a metadata mediating function 122 from either every available data stream of a single user on the network to every available user on the network, e.g., mass metadata, or any quantity of users or population definition of users in between. Mediating the metadata includes: primarily extracting the metadata portion of the data stream and discarding the balance of the data stream; establishing possible relationships between the communicated data; temporarily storing this data therein; delivering the metadata to other engines; and receiving feedback of target data, e.g., from target mediating function 112. After mediating the data, the relationship information and metadata itself is communicated to the advanced targeting function 124 which identifies a new target, i.e., an advanced target, to be intercepted on the network, and communicates it, as indicated by the dashed lines, to the mediation function 112 to then be provisioned per provisioning function 114 on accessing network function 116.

The advanced target and metadata analysis information can also pass to collecting and analyzing function 150 for displaying the results of the metadata, either directly, or in conjunction with data from mediation function 112. Together, the function of generating a new target, e.g., the advanced target, based on relationships algorithmically determined between metadata from intercepted data streams of both targets and/or non-targets is referred to as autoprovisioning. That is, the advanced target is provisioned automatically without requiring an ab initio input from a surveillance user, thereby resulting in the interception of data streams more timely and with fewer resources.

A third data path from accessing function 116 to intercepting function 140 intercepts data streams from the network and communicates them to storing data function 142 for storage of data. Third data path in one embodiment neither dissects data streams, e.g., content from data, nor, process them beyond tagging, storing, retrieving, and overwriting them. Thus, the third data path can store any desired portion of data, whether target or non-target data and whether metadata or content data. In one embodiment, third data path stores both content and metadata for every available data stream of all available users on the network and communicates them to circular buffer functional block 142 for storage of data. However, many different embodiments can be realized with third data path, from recording different portions of a data stream, e.g., content or metadata, for any population of communication network users, e.g., targets or non-targets or suspected targets, with any kind of retention duration algorithm.

Target mediating function 112 can request target and non-target retained data from storing data function 142 for retrieval and communication to collecting and analyzing block 150 and subsequently to displaying data GUI function 152. Thus, collecting and analyzing function 150 can receive data from a plurality of sources via mediation function 112, including essentially real-time intercepted data streams for target and advanced target from function 130, real-time metadata from advanced targeting functional block 124, and retained, or saved and intercepted, data from circular buffer function 142. The latter function is referred to as retained data recovery.

By tagging, e.g., in a header, each intercepted data stream with an identifier, i.e. a target identification (ID) that is unique to the network surveillance system, the intercepted data can be routed and managed through the network surveillance system as traditional data packets. A database, look up table (LUT), or any other system for tracking data can be utilized by components in the network surveillance system to cross-reference the unique identifier in the data stream with details about the data stream including target status, surveillance administration details, and other useful fields.

Overall, functional block diagram 100 illustrates several features including: a multi-path approach for parallely processing different levels of metadata and/or content from users of a network whether as targets or as non-targets; a dynamic feedback retrieval system for identifying advanced targets, using among other things metadata from all users on a network in conjunction with data from a target; autoprovisioning of the advanced targets to access functions for intercepting data; recovery of retained data based on target or advanced target needs; mediating of intercepted data using scaled mediation functions; managing packets through the NSS via target ID; and collecting and analyzing functions of data received from a plurality of parallel sources.

### System Architecture

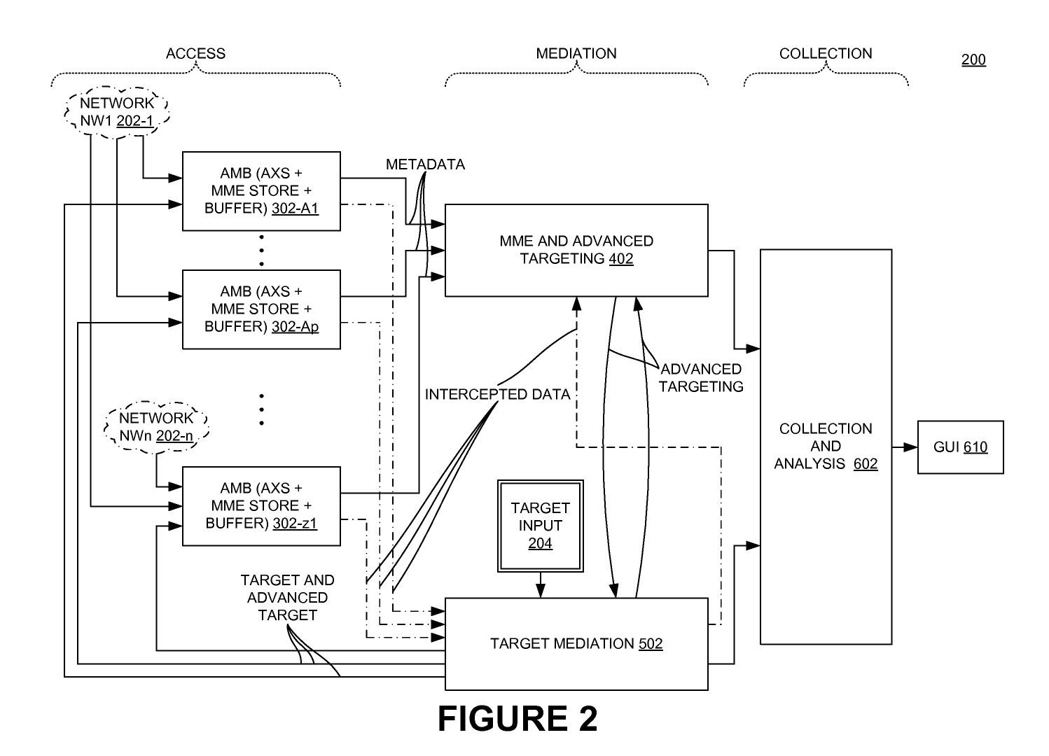

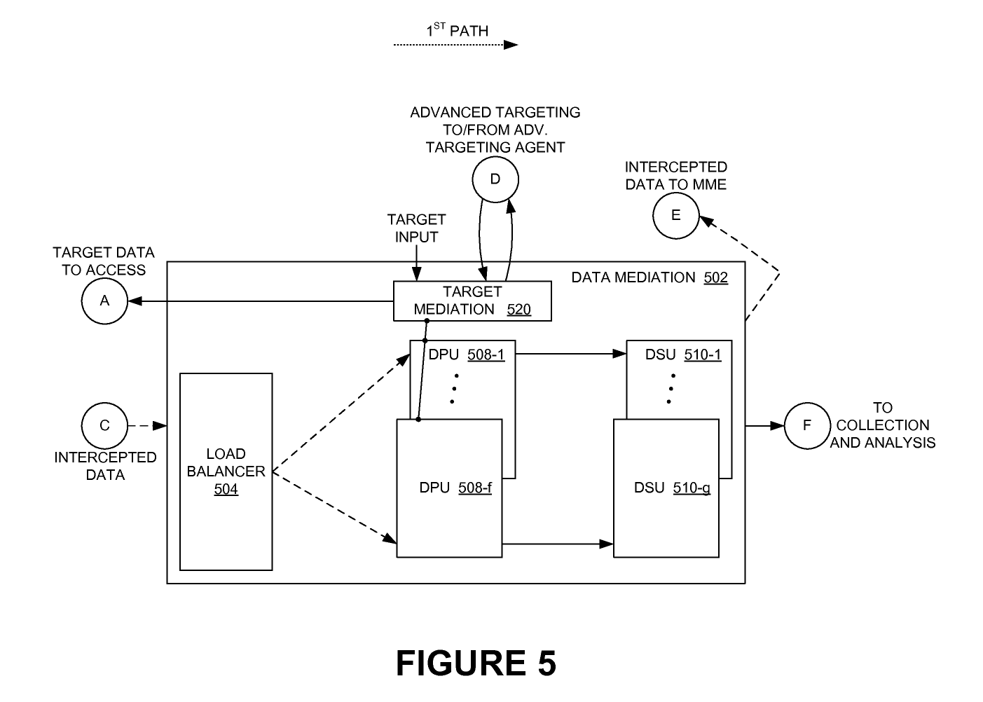

Referring now to FIG. 2, an architecture layout of the network security system (NSS) 200 as applied to a plurality of networks is shown, according to one or more embodiments. Target input block 204 is a graphical user interface (GUI) that can be a centralized data entry point or a distributed and remotely accessed interface that performs the target entry function of block 110 of FIG. 1. Input block 204 can be hardware and software such as a computer system with keyboard data entry, scanner and optical character recognition, or any other system to enter data. While only one target input block 204 is shown, the present system is capable of coupling a plurality of target input blocks, where one or more can be utilized by one or more authorized NSS users, e.g., LEAs such as FBI, DEA, CIA, CIC, local police, etc. Data mediation engine 502 receives target information from target input block 204, to which it is coupled, and mediates the target information per the functionality of block 112 of FIG. 1. Data mediation engine 502 can process intercepted data streams from targets and non-targets, via standard scalable network components as described in subsequent FIG. 5, or it can use an application specific integrated circuit and hardware

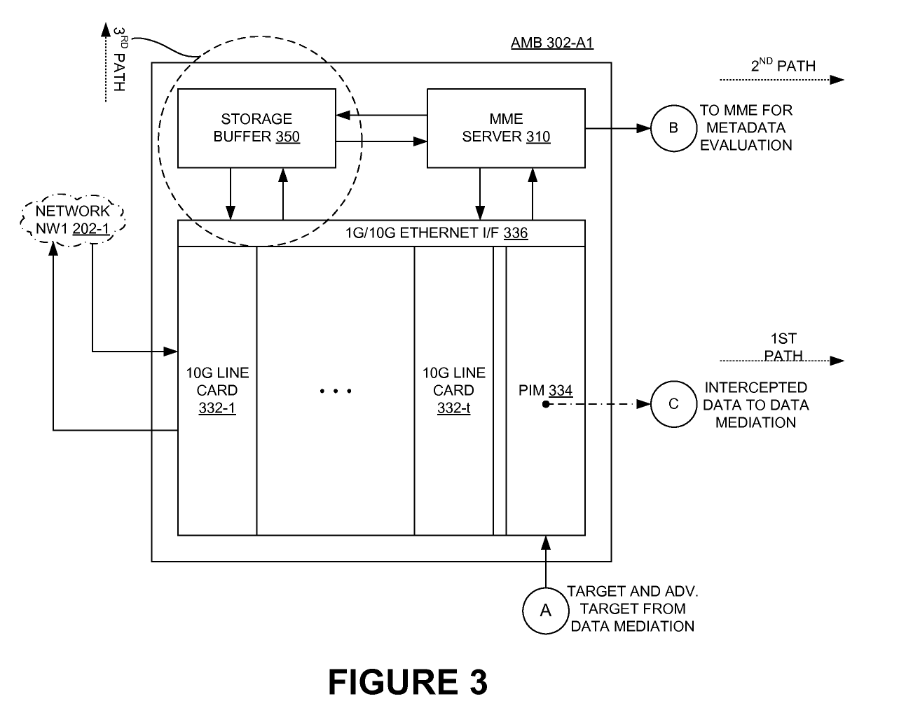

One or more Access+mass Metadata extraction (MME) storage+Buffer (AMB) devices 302-A1 to 302-Ap and 302-z1 are coupled on the backend to data mediation engine 502 to receive instructions on the target and advanced target that they should intercept on one or more networks (NW), e.g., NW1 202-1 and NWn 202-n, where n and p≧0. An AMB device, e.g., 302-z1 can be coupled to a plurality of networks, e.g., 202-1 and 202-n, or a plurality of AMB devices, e.g., 302-A1 and 302-Ap can be coupled to a single network, e.g., NW1 202-1. AMB devices 302-A1, to 302-Ap and 302-z1 utilize hardware and software described in subsequent FIG. 3 to perform the functions of FIG. 1 including: access network functional block 116; intercepting metadata of at least one or of all data streams per block 120; intercepting data streams of targets 130; and intercepting data streams of all users 140. Instructions may be communicated to AMB devices via secure, or encrypted, links on wired systems, wireless, satellite, etc.

AMB devices 302-A1 to 302-Ap and 302-z1 are also coupled to a plurality of processing devices on the frontend, and particularly to: a mass metadata extraction (MME) and advanced targeting engine, or metadata mediation engine, 402 that receives metadata; and to data mediation engine, 502 that receives intercepted data. Data mediation engine 502 performs the mediation function 112 of FIG. 1 where it mediates the target against rules and criteria for interception on the network as well as against available resource allocation. Data mediation engine 502 then communicates processed data from targets and advanced targets to collection and analysis engine 602, and also to metadata mediation engine 402 for processing against metadata from all users or a portion of users, e.g., to find meaningful relationships, correlations of data, and other insights into relationships between targets to other targets and to non-targets, which can be output to GUI 610, e.g., data monitors. Meanwhile, metadata mediation engine 402 is also coupled in parallel to data mediation engine 502 to send and receive data regarding advanced targeting.

NSS 200 is modular, such that a user can build up or scale down the functionality to a system as budget and need dictates. Thus, a core function of target interception can be a starting function, with an upgrade of autoprovisioning via metadata mediation, or an upgrade of retained data recovery via circular buffer being modularly addable. Thus hardware integration and expansion can be implemented with software upgrades and interface sensing techniques that allow the NSS 200 to detect the hardware and provision the system to implement the increased or decreased functionality.

Referring now to FIG. 3, a block diagram of the access device+mass metadata extraction (MME) server+storage buffer (together “AMB”) engine 302-A1 of the network security system is shown, for intercepting data on a network, according to one or more embodiments. Access function 116 of FIG. 1 is implemented in AMB engine 302-A1 via a scalable quantity of line cards, i.e., 10 Gigabit, or 10G, line cards 332-1 through 332-t with t≧0, being receive cards as required to intercept all content and metadata from all available traffic on the network, i.e., NW1 202-1, and to communicate it with other components in the network security system. Line cards 332-1 through 332-t receive data streams from the network via any commercially available or proprietary access device coupled to the network to intercept the data streams used by the targets. The access device can be a passive probe tied or tapped into a junction on the line of the network or it can be an active port to a network router, both of which are known to those skilled in the art; intercepting the data streams of the target on the network; optionally capable of tagging the data streams of the target that are intercepted from the network with a respective target ID or record ID; and transmitting the data streams of the target to the NSS for subsequent analysis.

Ethernet interface (I/F) 336 with 1G/10G capability and optional legacy compatibility, i.e., with 10/100/1000M bit/sec, communicates the full content and metadata of all available traffic on the network to the following coupled devices: 1) an MME server 310; 2) a peripheral control interface (PCI) mezzanine card (MC) input/output (I/O) module (together “PIM”) data card 334 and 3) a storage, or circular buffer 350. Note that any communication protocol can be utilized between engines or components in the NSS, e.g., 40G/100G, etc., while still meeting the functionality, methods, and overall system architecture and benefits of the present disclosure.

MME server 310 buffers and transmits metadata for users on the network to the metadata mediation engine 402 of FIG. 2, e.g., via connection “B,” thereby satisfying function 120 of intercepting metadata as second data path shown in FIG. 1. MME server 310 also functions to buffer and manage data to account for differences in line speed, line failures, data backup, and other system interconnectivity issues that inhibits continuous and real-time data streaming between the components.

PIM data card 334 is essentially the gate keeper for what portion of the data stream gets directed to the first data path of target mediation and the second data path of metadata mediation for the NSS. For example, PIM data card 334 can send the first few packets having raw metadata for a session for all users to the MME server 310 for subsequent transmission to metadata mediation engine 402 for processing metadata. Similarly, the PIM data card 334 can send the entire data stream for targets, including the first few packets having raw metadata and the subsequent packets containing the content, to the data mediation engine 502, shown in FIG. 2, e.g., via connection “C,” thereby satisfying function 130 that intercepts and stores data streams of targets as first data path, as shown in FIG. 1. Metadata belonging to the target is stripped out by data mediation engine 502 and communicated to, and processed in parallel by, metadata mediation engine 402, e.g., as tracked by a common target ID as shown in FIG. 2. PIM data card 334 can be a commercially available card, or a proprietary design PIM card capable of communicating with the packets as described herein.

Storage, or circular, buffer, or drive, 350 receives and stores metadata and content of desired users, which can include targets, advanced targets and non-targets on a network, via the Ethernet interface card 336. Storage buffer 350 satisfies circular buffer functional block 142 and intercepting function 140 as third data path, as shown in FIG. 1 for temporary storage of all metadata and content intercepted for every available data stream of all available users, in one embodiment, on a network. Storage buffer 350 can be any size buffer device, translating to a time limit of original stored data for a given data rate, with optional expandability, and various data management techniques for interruption, recovery, and preservation of strings of critical data. Storage buffer can be accessed to recover retained data that was intercepted for a target, an advanced target, or a non-target, via an NSS user request input from data mediation engine 502, e.g., via connection “A,” or via an autoprovisioning function via MME server 310 from the metadata mediation engine 402 through data mediation engine 502. Storage buffer 350 can be any commercially available or proprietary design drive that will communicate with the system and store data.

Optionally, additional storage buffers, not shown, may be used in parallel with shown storage buffer 350. Additional storage buffers could use a hand-off technique whereby when a critical security event occurs, as notified by a surveillance user or an algorithm, e.g., sensing key terms or traffic from specific targets, non-targets, or NSS users, a first storage buffer that was actively recording data can stop overwriting its existing data, thus saving the most recent communications on the network at the time of the notice. This would provide a ‘snapshot’ of the existing communications on networks up to that point which can be downloaded to other storage devices, e.g., long term or off-site storage devices. Going forward, recording of current communications on the network is seamlessly and losslessly transferred to the parallel circular buffer unit. Thus, the most recent past data is preserved, while current and future data is captured as well. In other words, multiple banks of storage buffers can serially store data e.g., via flip-flopping or round robin, until an event occurs, at which point, the most recent storage buffer changes to a download mode, while the unused storage buffer is swapped to assume the duty of recording current communications. Storage buffer 350 can be either an external unit communicating to AMB 302-A1 or it can be a unit integrated into AMB 302-A1. Storage buffer 350 is coupled to MME server 310 to provide data back and forth between the units.

While FIGS. 2 and 3 illustrate an integrated storage buffer 350 and MME server 310 located in each AMB engine, e.g., as a card in a blade server, for element 302-A1, the present disclosure is well suited to implementing the functions in a distributed metadata server device and storage buffer device, either as a standalone or incorporated in another engine, i.e., the metadata mediation engine 402.

Additionally, while AMB 302-A1 is illustrated for intercepting communications on a hardwire communication system, e.g., electromagnetic signal communication on copper lines or electromagnetic light waves on a fiber optic line via taps, etc., it can also be implemented via receivers or probes on other communication links such as wireless, e.g., satellite, radio signals including microwave, cellular communications, etc., via either intercepting that link in its domain, e.g., wirelessly on the airwaves, or intercepting it in the wired domain, e.g., accessing cellular communications when transmitting through hardwire links in the mobile telephone switching office (MTSO) or via a subscribers wireless fidelity (Wi-Fi™) network

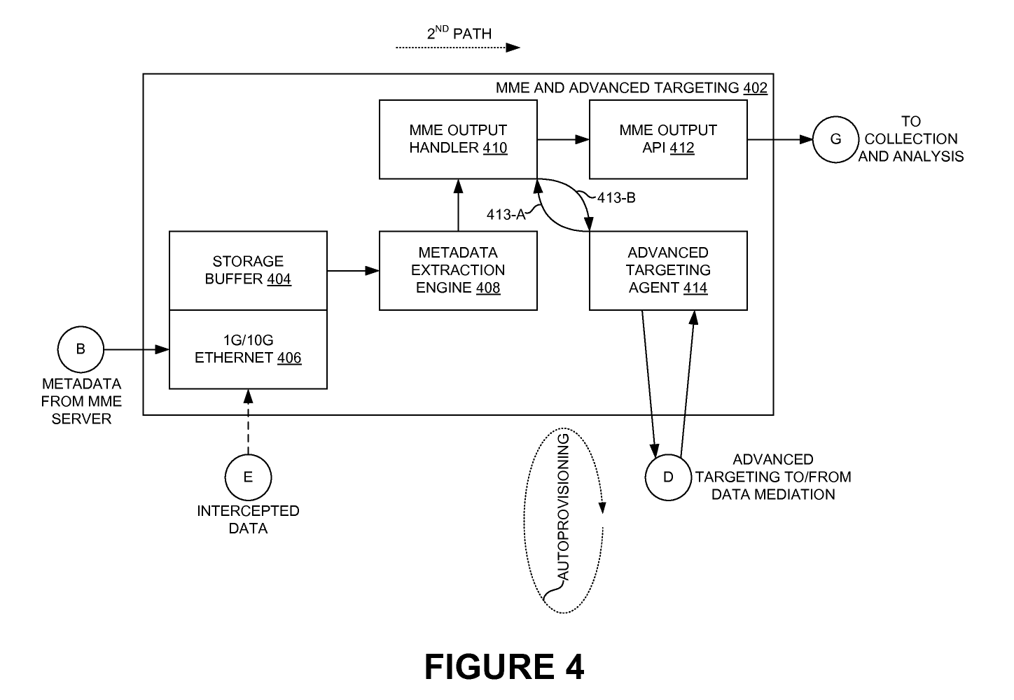

Referring now to FIG. 4, a block diagram of a mass metadata extraction (MME) and advanced targeting engine, or metadata mediation engine, 402 portion of the network security system, for evaluating a metadata portion of the network traffic, is shown, according to one or more embodiments. Metadata mediation engine 402 embodies the metadata mediation functions 122 and advanced targeting function 124 of FIG. 1 for second data path.

MME and Advanced Targeting engine 402 includes a 1G/10G Ethernet card 406 coupled to a storage buffer 404, for receiving and buffering the first few packets of raw metadata for each session, e.g., primarily for non-targets as received from MME server 310, via connection “B” from AMB engine 302-A1 of FIG. 3, and for receiving and buffering intercepted data, e.g., for targets and advanced targets, via connection “E” from data mediation engine 502 of FIG. 1. Thereafter, both the first few packets with the raw metadata and the intercepted data is communicated to metadata extraction engine 408, which strips and retains, the metadata portion of the raw metadata and the intercepted data, and communicates the processed metadata to the MME output handler 410, while discarding the rest of the content. The MME output handler 410 groups, labels, and packetizes the metadata for subsequent communication to the MME output application programming interface (API) 412 for transmission to collection and analysis engine 602, via connection “G.” Metadata extraction engine 408 is implemented in one embodiment using any commercially available deep packet inspection solution for inspecting and/or filtering of the packets for advanced network management, user service, and security functions as well as internet data mining, eavesdropping, and censorship.

Advanced targeting function 124 of FIG. 1 is specifically accomplished by advanced targeting agent engine 414 communicating with both MME output handler 410 for target update 413-B and target configuration 413-A as well as with data mediation engine 502 of FIG. 1, via connection “D.” In particular, advanced targeting agent engine 414 implements algorithms and recursive analysis to infer relationships and correlations between target data received from data mediation engine 502 and metadata portions of targets and non-targets intercepted on the network. The newly identified non-target is then labeled as a ‘target’ and communicated to data mediation engine 502 for provisioning as an intercept on the network via the AMB engine of FIG. 3. Storage buffer 404, metadata extraction engine 408, MME output handler 410, advanced targeting agent engine 414, and MME output API 412 can all be implemented as discrete devices or as integrated functions on a personal computer, minicomputer, server or other suitable device.

Referring now to FIG. 5, a block diagram of a data mediation engine 502 portion of the network security system for provisioning targets to be intercepted and for mediating intercepted data is shown, according to one or more embodiments. Data mediation engine 502 embodies the mediation function 112 for targets and advanced targets for both first data path and second path, as shown in FIG. 1.

Data mediation engine 502 includes a load balancer 504 for receiving intercepted data, including targets and advance targets, per connection “C,” from at least one AMBs 302-A1 to 302-Ap through 302-z1, and spraying, or distributing, the data across one or more data processing units (DPUs) 508-1 through 508-f coupled to one or more data storage units (DSUs) 510-1 through 510-g, respectively, and together referred to as data processing engines, where f≧0 and g≧0 and in some cases f=g for matched paring between the units, though multiplexing can occur with f being different than g.

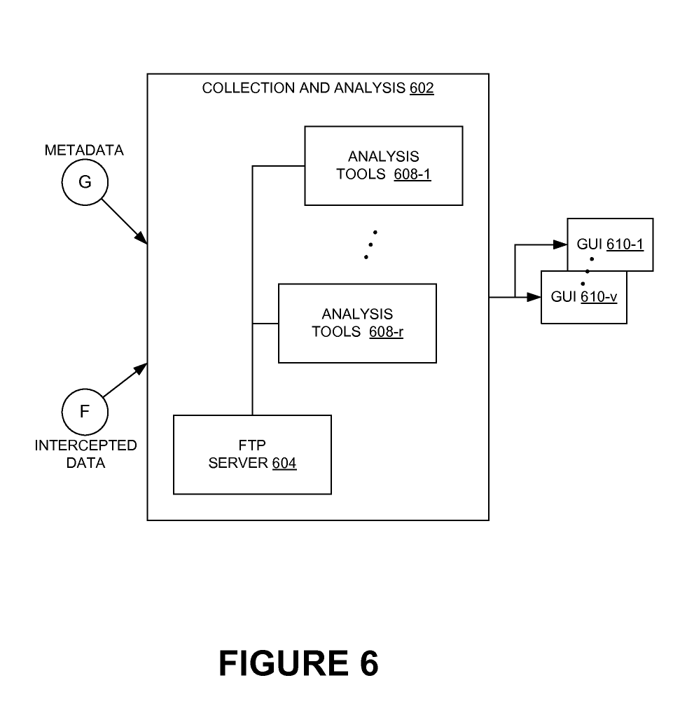

The DPUs 508-1 through 508-f, also known as an internetwork protocol data units (IPDUs), organize the intercepted packets for content delivery, eliminate any packets not authorized to be captured, fan-out packets destined for multiple LEAs and ensure the packet is only sent once to a LEA that has multiple targets that request the same packet and routes them to the DSUs for temporary storage for subsequent communication to collection and analysis engine 602 of FIG. 6, per connector “F.” In addition, DPUs 508-1 to 508-f are coupled to target mediation engine 520 which receives potential advanced targets from metadata mediation engine 402 of FIG. 4, per connector “D,” and compares them to actual targets being processed in DPUs 508-1 to 508-f as well as performing administrative tracking and approval of potential advanced target before provisioning them to AMBs 302-A1 to 302-Ap through 302-z1, via connector “A.” DPUs and DSUs can be proprietary communication cards or off-the-shelf line cards. Any commercially available or proprietary-design DPU may be used for this function, given the adaptation and implementation of drivers specific to the actual device. Target mediation engine 520 can be implemented as a discrete ASIC device or as an integrated function on a personal computer, minicomputer, server or other suitable device.

While only one load balancer 504 is illustrated, the data mediation engine 502 can utilize any number of load balancers and any quantity of data processing engines to provide a scalable system based on the quantity of data streams, based on the data rates, and based on any other application or customer needs to provide a functional system. A modular network chassis can be utilized with any quantity of slots for line cards or application specific engines to accommodate data processing engines.

Referring now to FIG. 6, a block diagram of a collection and analysis engine 602 of the network security system for analyzing and presenting intercepted data to the network security system user is shown, according to one or more embodiments. The collection and analysis engine 602 embodies the collecting and analyzing function 150 for intercepted data from the network, as shown in FIG. 1.

A plurality of sources provide information delivered to collection and analysis engine 602, namely metadata information via connection “G” from metadata mediation engine 402 of FIG. 4, and intercepted data via connection “F” from data mediation engine 502 of FIG. 5. This received information is interfaced by file transfer protocol (“FTP”) server 604 and distributed in parallel to at least one scalable analysis tools engines 608-1 through 608-r, with r≧0. In particular analysis tools engines 608-1 through 608-r can be proprietary application specific hardware tool, or can be a general processor such as a server. Analysis tools engines 608-1 through 608-r can be a combination of one or more analysis platforms or solutions provided by one or more companies. Analysis GUIs 610-1 through 610-v, where v≧0, are multiplexed to analysis tools engines 608-1 through 608-r to allow concurrent access, such that security and confidentiality is maintained between multiple different surveillance users, e.g., NSS users or LEAs, while the multiple surveillance users are accessing and analyzing their authorized information on targets and non-targets on the NSS, e.g., using metadata mediation, target mediation, circular storage retained data recovery, autoprovisioning, and/or different analysis tools engines. Analysis tools engines 608-1 through 608-r can include proprietary tools known to those of ordinary skill in the art of network analysis or legal interception. This enables the multi-tenant functionality of the NSS including a situation where same target or non-target data and/or analysis is provided by a fanout feature to multiple NSS users, e.g., to LEAs with appropriate authorization.

Servers mentioned hereinabove, e.g., MME server 310, server for metadata mediation engine 402, server for data mediation engine 502, or FTP server 604, or any other function in the scalable network surveillance system, can be any brand of server, e.g., Sun™, HP™, etc., and any type of server computer, e.g., application server, blade server or any processing device capable of performing the data management and communication functions with any quantity of cores, e.g., six (6) core X86 Intel Quad Xeon MP, which can be programmed for any type of operating system (“OS”), e.g., Solaris, UNIX, LINUX, or other computing OSs.

### Case Table

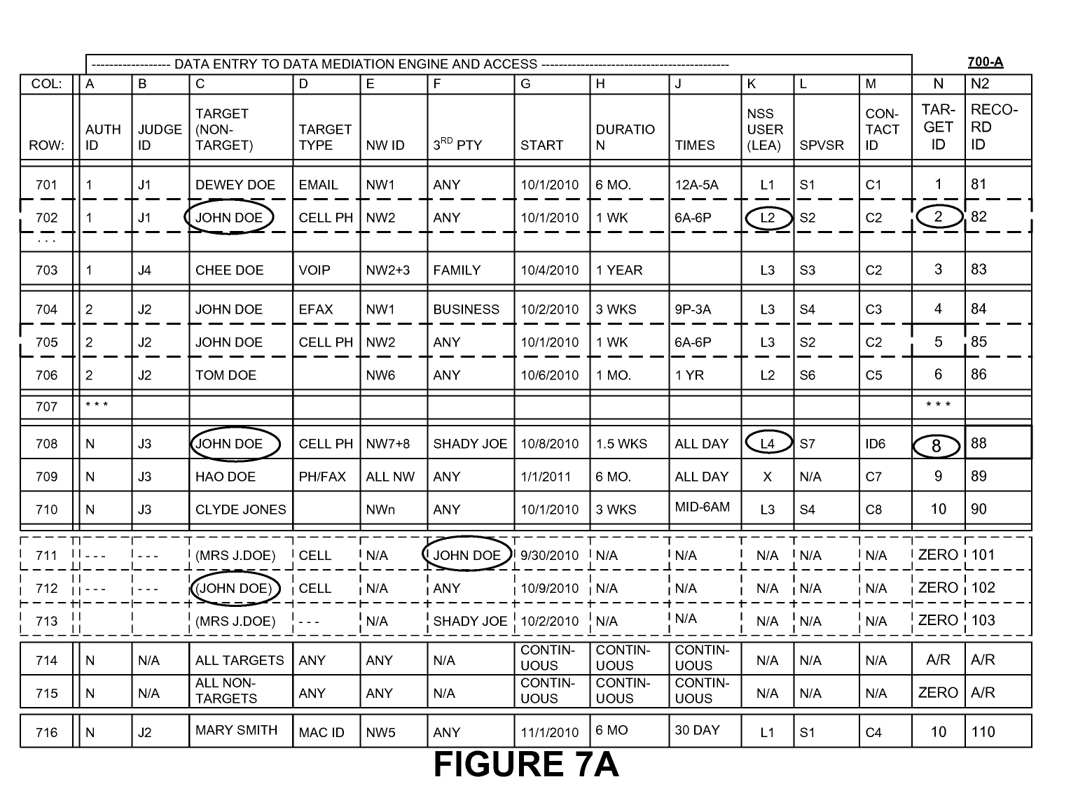

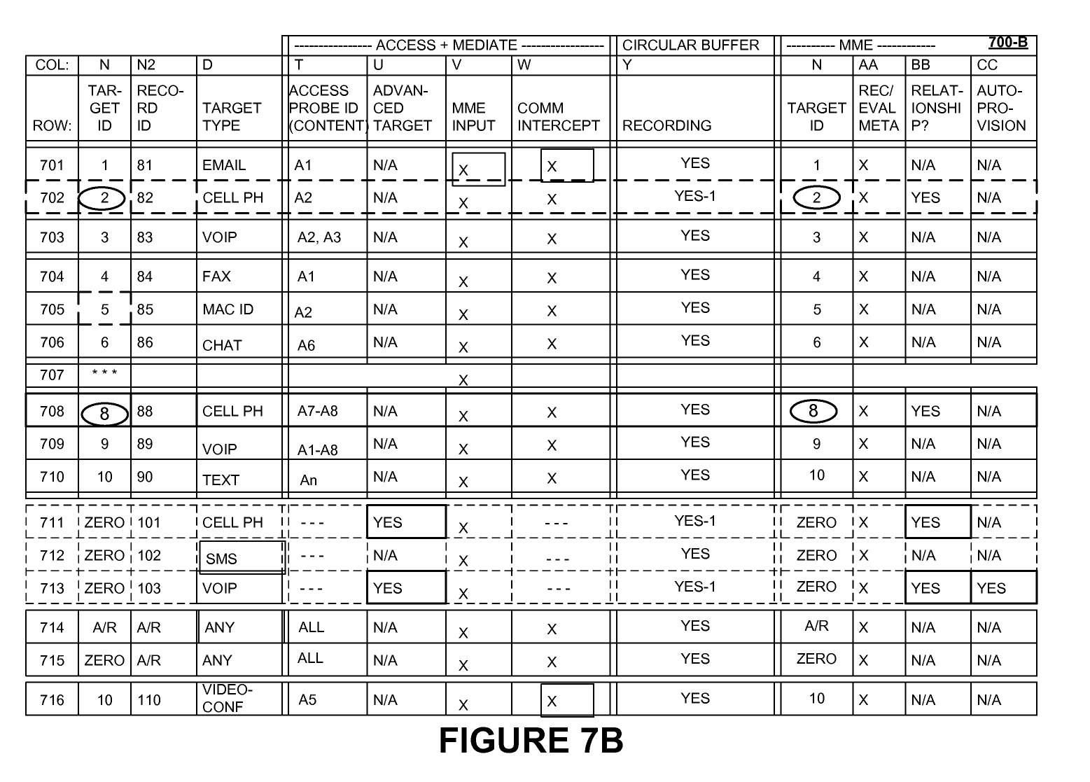

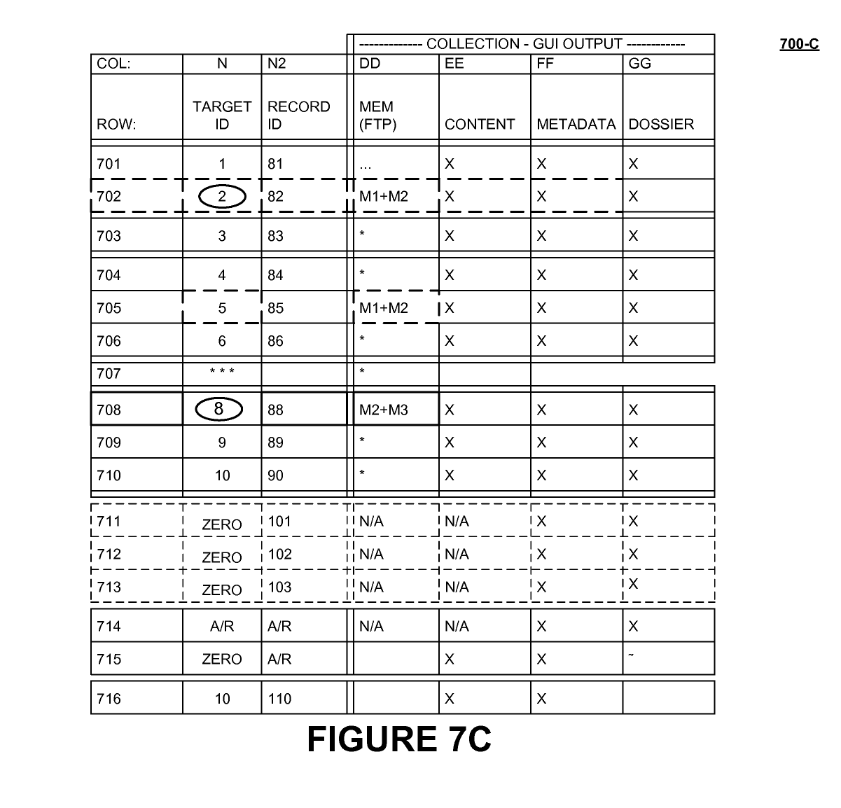

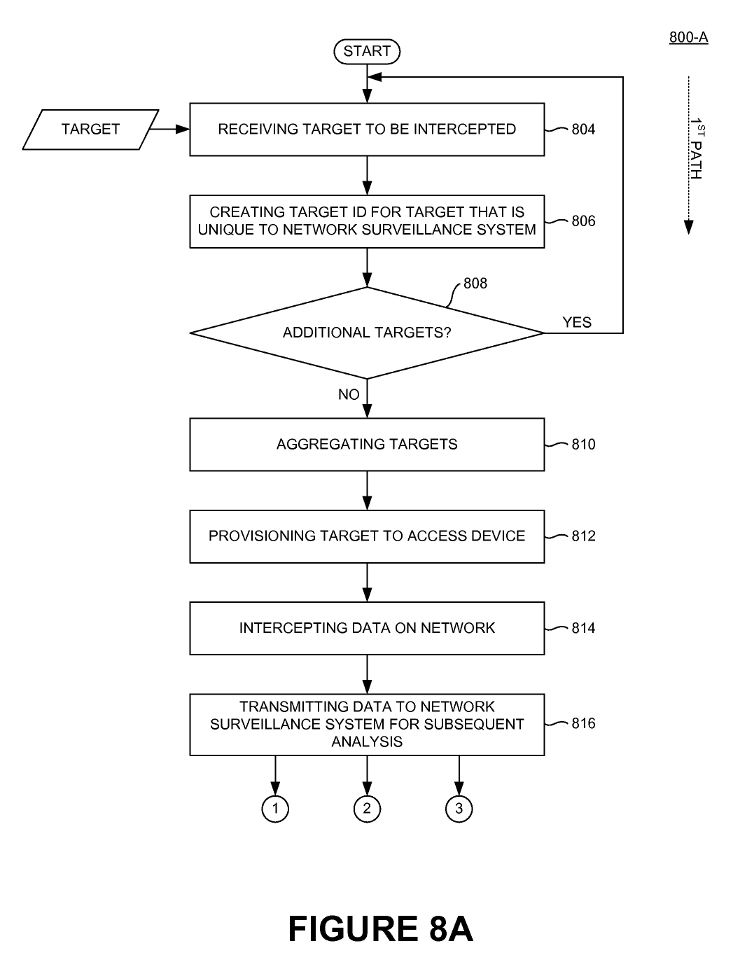

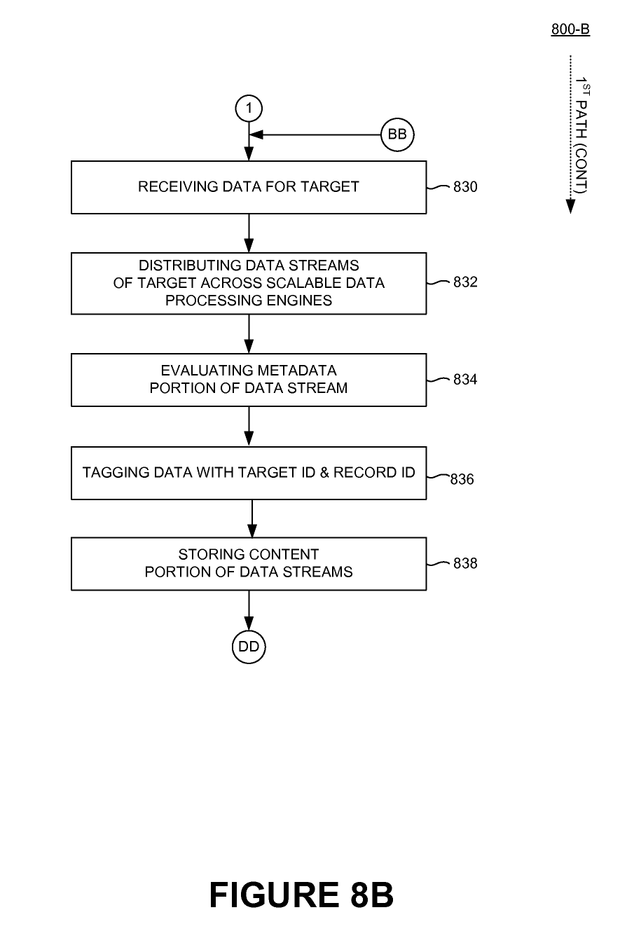

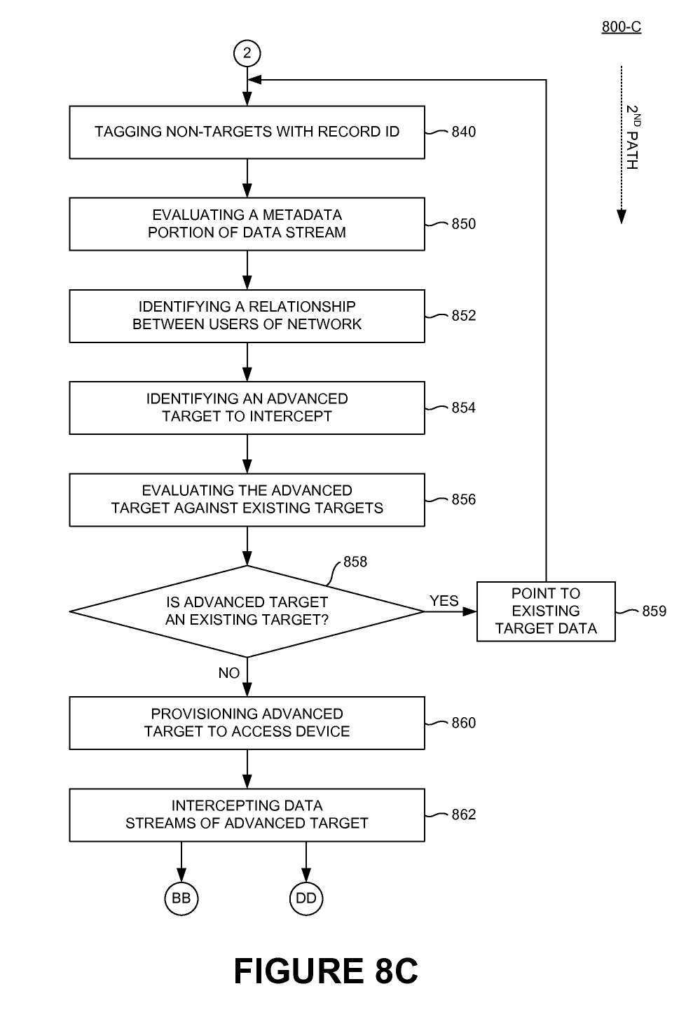

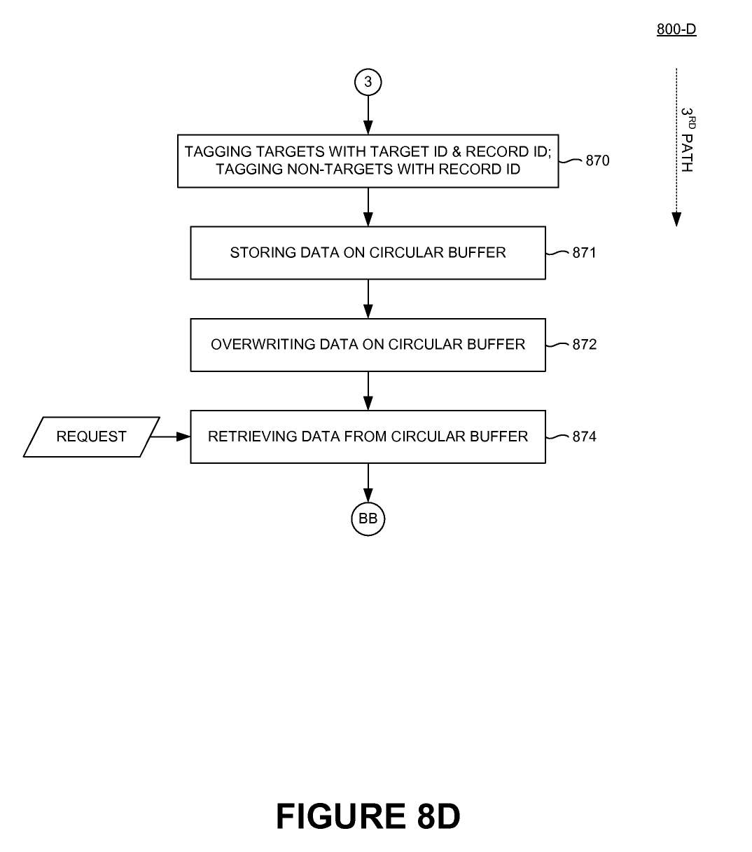

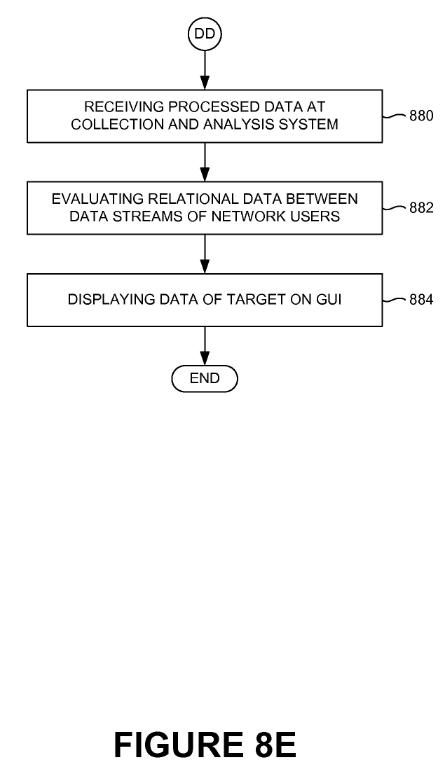

Referring now to FIGS. 7A through 7C, case tables 700-A through 700-C illustrating several different possible combinations of targets and non-targets communicating on a network to be intercepted are shown, according to one or more embodiments. Descriptions of columns A through column GG for case table are described immediately hereafter as exemplary fields, which fields are able to be reduced or expanded as desired by a given network surveillance system or user. Column letters I, O, Q, S, X, and Z are intentionally omitted. The substantive entries for each case, e.g., each cell in rows 701-716 of data in the table, are fictitious and provided as arbitrary examples to illustrate the disclosure, and will be described in respective portions of flowcharts of FIG. 8. All or part of case tables 700-A through 700-C, and additional management data, can be implemented as a lookup table (LUT) in memory managed by a controller or microprocessor of NSS complying with protocol instructions, e.g., per the method of a first data path of metadata and content for targets, second data path of metadata only for some or all users, and third data path of metadata and content for all or selected users, as described for FIG. 1.

Referring now to FIG. 7A, a case table 700-A illustrating data entry to data mediation engine and access function, showing several different possible combinations of intercept scenarios for targets and non-targets communicating on a network, is shown according to one or more embodiments. Columns A through N2 of table 700-A illustrate data entry values provided to data mediation engine 502 via target input block 204 shown in FIG. 2, viz., as input by a surveillance user. In particular, column A of case table 700-A is an authorization identification (AUTH ID), or warrant identification. Thus entries can be coded to uniquely identify a given warrant, e.g., a jurisdiction and a case number. Column B provides a judge identifier (JUDGE ID), while column C provides a target, e.g., a target name for an individual or a company name for a corporation, or a pseudonym, handle, nom de plume, nom de guerre, alias, chat room name, or other identifier. Column C also includes parenthetical non-target names in rows 711, 712, and 713. Column D provides a target type, such as the medium, link, channel, or other communication media or format on which metadata and content is communicated, thereby indicating what network or format should be provisioned for interception. Column E refers to a network identification (NW ID) on which the communication is sought. No column is provided for metadata, as it is presumed that metadata is available for interception on all users, including both targets and non-targets, without requiring a warrant. This is because metadata is not the content portion of a data that would otherwise be protected as personal content by privacy laws in some jurisdictions from unreasonable search or seizure.

Column F refers to a third party (3^{rd} PTY) Y) to whom a target is communicating, e.g., if a warrant limits surveillance to communications to only allow or except certain individuals. Columns G, H, and J refer to timing of when surveillance and interception is sought, e.g., a start day or date, a duration time or ending date, and times of day during which a warrant, or a user, prescribes surveillance, respectively. Column K lists the network surveillance system (NSS) user, e.g., a law enforcement agency (LEA), or a given employee of a LEA, while the user's supervisor or manager is listed in column L, and while a preauthorized contact identification (CONTACT ID) is listed in column M. Column N refers to a target ID that is assigned by the network surveillance system to the unique case described in the table, e.g., the given combination of variables, or fields, for the given target. Similarly, column N2 refers to a record ID that is assigned by the network surveillance system as well, in order to unique case described in the table for targets and non-targets. Thus, with a unique target ID and/or record ID, the data streams, or packets of data, can be tagged or wrapped, e.g., in the header of a packet, with the unique target ID and record ID. This allows the packet to be processed in the NSS as a discrete and traceable packet on fungible or proprietary, and scalable, hardware and engines, seeing as the unique target ID and/or record ID can be determined for a given packet, and thus its data can be intercepted and processed for the given target ID. A NSS could deselect some of the variables listed in the columns or add other columns such as, for example: target bio information such as social security number, driver's license number(s), etc.; warrant information such as previous historical instances, LEA information such as comments and suspected relationships to other targets, etc.

Rows 701 through 710 represent targets that are available to enter into an NSS at a given point in time. Row 716 is a target that only becomes known at a future point in time for entering into the NSS, and is thus segregated away from the targets ready to enter immediately. Rows 711-713 are non-targets presented in the table for comparison and explanation of subsequent steps on targets and non-targets, and are not typically entered into the LUT system for tracking target IDs. Row 714 represents all targets on all networks serviced by NSS while row 715 represents all non-targets on all networks serviced by NSS; together which represents all available users on all networks serviced by NSS.

Referring now to FIG. 7B, a table 700-B, illustrating functions of access and mediation, mass metadata processing, and circular buffer functions, e.g., first, second, and third path of data processing of FIG. 1, for data intercepted from targets and non-targets communicating on a network, is shown according to one or more embodiments. Column N target ID, and column N2 record ID, for targets and non targets respectively, are repeated in table 700-B because the target ID or record ID is retained with the intercepted data as it propagates through the NSS, and thus will be available to any engine in the NSS. Column D, target type, is repeated in table 700-B for convenience of reading the table. Table heading “Access+Mediate” includes columns T through W which represent variables used in AMB 302-A1, or access portion thereof, of FIG. 3 and data mediation engine 502 of FIG. 5 for processing of the data streams. In particular, column T identifies the Mediation user ID, for an administrator or user of the NSS that has access to the mediation functions of the NSS. Column T indicates an Access probe ID used to intercept data on a given network. In some cases, multiple probes will be used on a network, and thus, both probes may have to be provisioned and tracked. The probe IDs and network IDs used in tables 700-A and 700-B are exemplary and do not necessarily match NW IDs shown in preceding hardware figures. Column V indicates which target or non-target has mass metadata engine input (MME INPUT) to the NSS. Because all metadata is accessible by the NSS, including both targets and non-targets, every row has a check. However, the NSS user can selectively gain metadata information for whichever targets or non-targets desired, possibly based on prioritizing limited resources to only targets and to suspicious non-targets for a high-data rate scenario. Column W refers to communication intercept (COMM INTERCEPT), e.g., for content of communication, which in most scenarios is limited to targets, though certain jurisdictions will allow a NSS user to intercept content of non-targets as well. Table heading “Circular Buffer” includes column Y which indicates which data is being recorded in storage, or circular, buffer 350 of FIG. 3.

Table heading “MME” includes Column N; target ID, again for the MME function performed on the data. Column AA indicates whether the Metadata is recorded and evaluated by the MME mediation engine; while column BB indicate whether a network user has a relationship to a target, e.g., to target ID of “2” in this example; and while column CC indicates whether a newly auto provisioned target was established by the MME function.

Referring now to FIG. 7C, a table 700-C, illustrating collection and analysis of data provided by the network security system for GUI display, is shown according to one or more embodiments. Table 700-C includes column N target ID, and column N2 record ID, as these identifiers travel with the data stream through the NSS for target, non-targets, respectively. Table heading “Collection—GUI Output” includes: column DD for memory location in the FTP server 604 of FIG. 6; column EE to indicate content available to GUI output, column FF to indicate metadata available to GUI output, and column GG for dossier information available to GUI output, e.g., a summation of target and non-target related information and other NSS user comments and analysis. Note that memory location per column DD for common targets has row 702 utilizing memory locations M1+M2 and row 705 utilizing the same memory locations M1+M2, seeing as their target data matches in important areas, such as same target, same time of interception, etc., per Table 7A that would allow the access to that same data by different LEAs, e.g., LEA1 for row 702 and LEA3 for row 705, thus saving memory by storing the data once, all while maintaining confidentiality and security between the two LEAs, for multi-tenant.

### Method of Use

FIGS. 8A through 8C provide flowcharts illustrating a method of intercepting, managing, and processing data streams from a network for both targets and non-targets, according to one or more embodiments. The flowchart components, e.g., steps, will be described as applied to both apparatus and system components and to case tables provided herein.

Referring now to FIG. 8A, a flowchart 800-A of a method for intercepting data streams on a network is shown, according to one or more embodiments. Flowchart 800-A begins with step 804 of receiving at a network surveillance system (NSS), such as a lawful interception (LI) surveillance network, a target to be intercepted on the network. Step 804 is implemented by entering target information via target input 204 of FIG. 2 for columns A-M of table 700-A of FIG. 7A for targets belonging to a given NSS user, or surveillance system user or LEA user, in column K, typically segregated for security and confidentiality purposes. Thus, LEA L1 would enter their target info in columns A-M for “Dewey Doe” of row 701. Note that row 716 belonging to LEA L1 is not entered at this time because, for this example, it has been arbitrarily assumed that the warrant for “Mary Smith” was not available at the time of entering info for the balance of rows having warrants. Similarly, LEA L2 enters their target info in rows 702 for “John Doe”, and 706 for “Tom Doe,” while LEA L3 enters target info in rows 703 for “Chee Doe,” row 704 for John Doe, row 705 for “John Doe”, and row 710 for “Clyde Jones,” and while LEA L4 enters target info in rows 708 for “John Doe,” which is the same target and target type, e.g. cell phone, as row 702, but for a different LEA, different judge using the warrant, and other different factors. At some point in the future, LEA L1 would enter the information for row 716 for “Mary Smith,” which in this example would only be available at some time in the future. LEAs L1-L4 can enter data according to their own independent timetables, and their independent data input facility. Step 804 includes the creation of a target ID (TID) in target input 204 for the given target data entered into the NSS.

Alternatively, if implementing a multi-tenant feature of the present disclosure on the NSS, a given neutral administrator could be tasked with entering all target information for all LEAs using the present disclosure, because after being entered, the NSS via the look up table (LUT) would be able to discriminate which data belonged to which target belonged to which LEA, and could make that information only available to the given LEA with administrative privileges to see it.

Furthermore, with a multi-network feature of the present disclosure, a given LEA entering warrants for different systems would not have to enter them on different surveillance systems slated for different networks. Instead, a given LEA could enter the target information on a single NSS system for intercepting data streams for targets on different networks. Without the multi-network feature the surveillance user might have to enter target info on multiple surveillance systems, one for each communication network on which the target is suspected of communicating, e.g., for metadata, and optionally one on which a warrant authorizes, e.g., for content and metadata. Combined together, multi-tenant and multi-network could provide a single NSS with which a single administrator could enter target information for multiple surveillance users intercepting data on multiple networks, resulting in substantial reductions in turnaround times, bureaucratic conflicts, operating expense, and other resources.

Step 806 is for creating a target identification (target ID) for the target, wherein the target ID is unique to the NSS in order to track data streams of the target during subsequent processing, such as extraction of content and metadata, in the NSS. Step 806 is implemented by the NSS, and specifically the data mediation engine 502 of FIG. 2, by having an accounting system that provides unique target ID numbers for a given unique target, e.g., one having unique values for all the variables desired, e.g., some or all of columns A through M of table 700-A, all of which values presented in given rows 101-113 are unique with respect to each other. The NSS accounting system would also time out or delete, target ID values when a given target had expired or been expunged by a surveillance user. The target ID is unique for a combination of information chosen from a set of data including, but not limited to: the target, e.g., a target name, phone number, handle, etc; a target type associated with the target; relational data associated with the target such as a network provider ID, an intercept time and an intercept date, network ID, etc. A look up table (LUT) or other relational data or database system can be used to track the target and the data streams of the target.

Regarding multi-tenant and multi-network features, the different network values entered in columns K and E, respectively, provide another variable for the row, thus making them unique with respect to each other, and thereby resulting in different target IDs. For example, similar target John Doe in Row 702 and 708 has different tenants of LEA L2 and L4 as well as different networks NW2 and NW7, respectively.

Step 808 inquires whether additional targets are to be entered, and if so, returns to step 804 to repeat steps of receiving a target and creating a target ID, so the target can be provisioned and intercepted in a group. Step 808 is implemented in table 700-A by entering information for targets that haven't been entered or are newly available, e.g., for rows 701-710 currently, or for row 716 when it is available in the future. Row 705 can be entered at the time it becomes available.

Step 810 implements optional aggregating of the targets received at the NSS to determine a superset of data streams to be provisioned and intercepted in order to prevent duplication of effort and data in the NSS, due to the intensive storage requirements of current high data rate communications. Step 810 is implemented by data mediation engine 502 examining via software algorithms and comparing values in memory for all entered targets and seeking any rows that are identical for all appropriate fields. The aggregating step can also provide hierarchical grouping functions per user-defined fields, e.g., primarily grouping targets per the network to which they are listed, secondarily grouping targets by date, etc.

Step 812 involves provisioning a list of target IDs via a data mediation engine 502 to access device(s), e.g., AMB 302-A1, of FIG. 2 in order to intercept data streams used by the targets on one or more networks. The provisioning step can include provisioning multiple access devices for a given network, e.g., AMB 302-A1 and 302-Ap coupled to network NW1 202-1. In particular, step 812 is implemented by communicating target type information of column D assigned by data mediation engine 502 per algorithms developed to target given data communication types and links, e.g., phone number, webmail address, etc.

Step 814 implements intercepting data on the network. In one embodiment, only target data is intercepted on the network, by searching for strings of identifiers in traffic that match identifiers of target sought, e.g., the target name, or alias, per column C, or target type, per column D, and given chronology variables as in columns G, H and J, amongst other potentially important variables, such as the third-person to whom a target is communicating, e.g., column F. In another embodiment, the entire data stream, including both metadata and content, for all available users of the network, is intercepted and then segregated into appropriate portions of data depending on an application and level of interception desired by a surveillance user. Other embodiments can be implemented in step 814 to retrieve: portions of data streams, e.g., content and/or metadata; for targets, non-targets, portions thereof, or any population of communication network users that NSS defines, e.g., by an ad hoc or an algorithmic rule.

The interception function is implemented by either an active or passive probe that communicates intercepted data streams from the network to the line card of the AMB device, e.g., AMB 302-A1 of FIG. 3. If an AMB is acting as an active device, then it plugs directly into a port on the network device, e.g., an Internet router, designed for intercept, wherein the network signals are communicated directly to 10G line card 332-1. If an AMB is acting as a passive device, e.g., a probe, then an inductive head, that is not shown but known to those skilled in the art, is placed on the existing communication line, e.g., electromagnetic waves on copper lines and light waves on a fiber optic line, etc., to sense and intercept the signals thereon and communicate them into the 10G line card 332-1. In one embodiment, the entire data signal, e.g., content and metadata, of all available users on the network are communicated to the AMB device for access. The different quantities of intercepted data are segregated and split off for different levels of processing as described in a subsequent step. The present disclosure is well-suited to intercepting a wide range of signal types and a wide range of one or more intercept conditions, seeing as content and metadata can be analyzed to determine compliance with a given intercept condition.

Step 816 is for transmitting the intercepted data streams to the NSS for subsequent analysis. Step 816 is implemented differently depending upon what types of data streams are being intercepted. In one embodiment, parallel data paths, as described in FIG. 1 of a first, second, and third data path, are communicated in parallel to different respective portions of a NSS for processing according to the protocol of the specific data path. In the present embodiment, the metadata and content for all available users of the network is communicated to engines in each of the three data paths, where the data is then reduced as required by the protocol for that data path. Thus, in the present embodiment, the metadata and content for all available users of the network is communicated via: connector “1” to flowchart 800-B of FIG. 8B for processing of first data path; connector “2” to flowchart 800-C of FIG. 8C for processing of second data path, and connector “3” to flowchart 800-D of FIG. 8D for processing of third data path. Thus, the flow paths are: 1) target mediation of first data path which will strip out and analyze the content portion of data stream for targets, including advanced targets, and pass the first few packets of the data stream containing primarily raw metadata to the metadata mediation of second data path; 2) while similarly the first few data packets of all non-users are sent to the metadata mediation of the second data path in parallel, wherein the metadata is further refined; and 3) while retained data mediation of third data path will accept and record data, e.g., both metadata and content, of desired data streams, e.g., all communication network users.

Referring now to FIG. 8B, flowchart 800-B, continued via connector “1” from FIG. 8A, of a method of mediating the intercepted target data, is shown according to one or more embodiments. Flowchart 800-B embodies the first data path function of the NSS illustrated in FIG. 1 starting with step 830 of receiving the metadata and content for all available users of the network from the access portion of the NSS via connector “C” of FIG. 5, at the load balancer 504. When a data stream containing metadata, content or both are received at the load balancer 504, then it proceeds directly to subsequent distributing step.

Step 832 is for distributing the data streams across a scalable quantity of data processing engines, such as data processing units (DPUs) and data storage units (DSUs), in the NSS. Step 832 is implemented by load balancer 504 distributing, or spraying, data streams across the scalable quantity of DPUs 508-1 to 508-f and then to subsequent DSUs 510-1 to 510-g, together “data processing engines.” The process of distributing or spraying the data streams can be done according to balancing a quantity of data streams themselves, or balancing a quantity of data in the data streams. The present embodiment balances the quantity of data streams across the scalable quantity of data processing engines. A modulo-x algorithm may be used where ‘x’ is the quantity of branches or parallel data processing engines that are used. Thus, if values ‘f’ and ‘g’ equal 4 for the DPUs and DSUs, then a modulo-4 algorithm would be used to deal one out of every four a sequential data streams to each of the multiple DPU and DSU sets. Other techniques for load balancing and traffic management in an even or a biased distribution across the multiple DPUs and DSUs can be implemented in the present disclosure as well.

In step 834, evaluating a metadata portion of the data streams is performed using a scalable quantity of DPUs. This step essentially screens the metadata and content for all available users of the network for target data. Step 834 is implemented by DPUs examining the metadata portion of the data stream and comparing it to the target ID criteria of LUT as exemplified in Table 700-A of FIG. 7A. Data streams that do not qualify as targets do not advance to DSU units 510-1 to 510-g. Thus, while the metadata and content for all available users of the network may be evenly distributed across multiple DPUs, the resulting target data streams that pass to the multiple DSUs may not be evenly distributed. A feedback loop to load balancer from multiple DSUs 510-1 to 510-g may help to more evenly distribute data streams if a given DSU becomes burdened with a higher than normal traffic rate.

Step 836 implements tagging the data streams of the target that are intercepted from the network, with a respective target ID and optionally a record ID. Thus for example, when a cell phone communication is discovered on a cell network, e.g., via active interception into the mobile traffic switching office (MTSO) or via packetized cell data passed on a network such as the Internet, for target John Doe, per Row 702 of Table 700-A having a target ID of “2,” and a record ID of “82,” then this target ID and record ID is then embedded, e.g., in the header, in the data stream for future reference during processing in the NSS or collection and analysis by a surveillance user. Thus data intercepted for rows 701 through 710 will be tagged with respective target IDs 1-10, and record IDs 81-90 respectively. Step 836 tagging can be implemented in various alternative embodiments, with either access components performing the tagging, or with mediation engines performing the tagging step. In one embodiment, tagging can occur at the time a data stream is intercepted, e.g., for targets, or at a later time, such as when retained record is retrieved from a historical file and redesignated as a new target or an advanced and is now tagged and entered into the NSS for processing and analysis. An example of retained data used for a new target would be when data is stored on the NSS from a network user that was originally a non-target but who has now become a target.

Step 836 can be implemented in different ways depending upon the number of modular features and functions integrated into their NSS. For example, an NSS can be configured to only mediate target content for the first data path, or to analyze metadata of non-targets and targets for the second data path, or to retain data for some or all of targets and non-targets for the third data path, or any combination of these functions. Thus, in another embodiment, data streams for targets are tagged with a target ID for analysis of content and tagged with record ID for analysis of metadata and/or for short-term retained data storage, while data streams for non-targets are tagged with a record ID for analysis of metadata and/or for short-term retained data storage in circular buffer. If targets are only mediated for target content for the first data path and are not analyzed for metadata, and their data is not retained for future use, then only a TID is used and a RID is not needed. Tagging a data stream with a record ID or a target ID can be implemented by using a wrapper around an existing packet in one embodiment. For retained data function, tagging of target ID and record ID for retained data stored in storage buffer 350 can be performed by MME server 310 of FIG. 3, or by Metadata extraction engine 408 of FIG. 4 and communicated back to storage buffer 350. For metadata mediation, tagging of record ID for a non-target, and target ID for a target, can also be performed by MME server 310 of FIG. 3, or by Metadata extraction engine 408 of FIG. 4.

Step 836 is implemented by target mediation engine 520 of FIG. 5 that receives metadata of data streams and evaluates the target, target type, and other factors of the data communication that allows the system to identify the data stream uniquely, per the LUT 700-A for example, and then tags the previously assigned target ID value into the respective data stream for subsequent processing in the NSS, e.g., the DPU 508-1 through 508-f and DSU 510-1 through 510-g, and subsequent engines.

With step 838, storing a content portion of the data streams is performed in a scalable quantity of data storage units DSUs 510-1 to 510-g as shown in FIG. 5. This storing process buffers the data streams before being passed via connection “F” to collection and analysis engine 602 of FIG. 6. Thereafter flowchart 800-B proceeds to connector “DD” which leads to FIG. 8E flowchart 800-E of a method for analysis and collection of data.

Referring now to FIG. 8C, a flowchart 800-C, continued via connector “2” from FIG. 8A, of a method of mass metadata extraction and analysis is shown, according to one or more embodiments. Flowchart 800-C embodies the optional second data path function, illustrated in FIGS. 1 and 2 of processing, e.g., intercepting and mediating, the mass metadata of at least one of the data streams, or of all the data streams of targets and/or non-targets on the network. Mass metadata extraction is a method of evaluating the metadata portion of all the data streams, which raises less legal issues because the metadata portion of the data streams are typically not protected by privacy laws. A substantial amount of relational data can be obtained between targets and non-targets, and combinations thereof, via the metadata.

Step 840 implements tagging the data streams of the non-targets that are intercepted from the network, with a respective record ID (RID) for subsequent metadata mediation. Thus for example, when a data stream of a new non-target is identified and the first few packets of the session are sent via MME server 310 to MME and Advanced Targeting 402, then metadata extraction engine 408 can assign a new record ID and tag or wrap the data received from access with the RID. For example, the data intercepted by access for rows 711 through 713 are non-targets and thus will be tagged with respective record IDs 101-103. RID for both targets and non-targets are any unique code for referencing or correlating, including either a: date/time stamp, a revolving number, or etc.

In step 850 the evaluating of the metadata portion of the data stream of all users of the network is performed, after receiving the metadata and content for all available users of the network from flowchart 800-A via connector “2,” at 1G/10G Ethernet interface 406 coupled to storage buffer 404 to accommodate bursts of data or variations of data rates between engines. Step 850 is implemented by metadata extraction engine 408 that evaluates the incoming the metadata and content for all available users of the network stream and removes only the metadata portion, e.g., the sender name, receiver name, date and time of transmission, size of communication, attachment file identification, subject line, size of attachment, format or file type of attachment, target type, protocol of communication, session identification, location, proxy server identification if applicable, and any other logistical information describing the content or the communication link, typically located in a header and/or footer. To locate the metadata, a deep packet inspection per protocol is performed on the data stream. First, the type of communication is identified, e.g., VOIP; Yahoo!™, Gmail™, or Hotmail™ email; chat; video streaming; etc. Then the metadata is retrieved based upon the protocol for that type of communication, which defines the location of the metadata, e.g., a specific bit location in the header of the first or second IP packet for an email. Depending on the protocol, the raw metadata can usually be extracted from the data stream, by line card 332-1 and PIM data card 334, as the first several packets of a session for a given communication network user with the balance of the packets in a data stream being discarded as not needed for metadata meditation. The term “mass metadata extraction” refers to extracting metadata from the entire mass of, e.g., all, users of a communication network. However, step 850 and metadata extraction engine 408 can be applied to any quantity of users of a system, from none to all available users.

MME server 310 can be programmed to send to metadata MME and Advanced Targeting 402 only the first several packets of a session that are known to contain the metadata, and not send the subsequent data packets that contain content. Alternatively, metadata mediation engine 402 can be programmed to provide a feedback to MME server 310 when the metadata for a given session has been retrieved and no further packets are necessary for the given session ID. If the data stream is being actively intercepted from the network, then that data is currently available. However, if the target was identified only after a session started, then MME server 310 can request storage buffer 350 to retrieve the retained data for the given target for delivery to metadata mediation engine 402, assuming the storage buffer is large enough and/or the retained data didn't occur too far in the past to be already overwritten.

Step 852 is for identifying a relationship between at least two of a plurality of data streams from a plurality of network users of a network, e.g., between targets to targets, or targets to non-targets, or non-targets to non-targets, and combinations thereof. Step 852 is implemented using mass metadata extraction (MME) output handler 410 which contains algorithms operated on a processor to tabulate metadata and list patterns and degrees of separation between network users, etc. As exemplified in FIG. 7A, the second data path function herein would produce the linking data between John Doe's target communications on row 702 and 708 along with the non-target communications of John Doe on row 711 and 712 and with the non-target communications of Mrs. J. Doe on row 713, assuming a LEA provided a link between Mrs. J. Doe and John Doe; or assuming metadata analysis provided linking logistical analysis, e.g., origination of communication by John Doe and Mrs. J. Doe from same physical address. The information of which network users contacted which network users, at what chronology information (time, date, duration, etc.), would be available to all surveillance users. And that information together with the target information available to LEA L2 and L4 for rows 702 and 708, respectively, a larger comprehensive picture can be established of the targets and other targets and non-targets that might become targets or advanced targets in the future, possibly based on the information gathered herein

Step 854 is for identifying an advanced target to intercept which is implemented in the present embodiment by algorithms based on experience, stochastic processes, and/or other factors, and combinations thereof. Step 854 is implemented by processor in MME and advanced targeting engine 402, and in particular by MME output handler 410 that implements these algorithms and rules. Thus, in the example provided for step 852, the relationship identified between Mrs. J. Doe communicating to John Doe on row 711, and then the subsequent communication from Mrs. J. Doe to Shady Joe on row 713 might raise the inference that Mrs. J. Doe should become a new target, or an advanced target, especially since John Doe is already a target with respect to communications with Shady Joe per row 708. In another embodiment, the existence of a target for a given LEA is utilized in step 854 for determining the strength of a case for creating an advanced target for another LEA, though none of the substantive data intercepted from a first LEA is directly given to a second LEA who does not have the target, without the second LEA generating the target per protocol themselves as prompted after generation per advanced targeting. While the example provided simply linked communications between network users, much more sophisticated linking can occur using other variables and fields from metadata, e.g., a common subject reference, a meeting location, a same attachment to an email, etc.

Step 858 inquires whether the advanced target is listed as an existing target already for purposes of avoiding duplication of effort. In particular, step 858 inquires whether a new target for a second LEA already exists as an existing target for a first LEA. Step 858 is implemented by advanced targeting agent engine 414 communicating to MME output handler 410 the results of a search through existing targets in its memory for one that matches a desired new target, or auto target sought by MME output handler 410. If the requested new target, or auto target already exists, then a pointer per step 859 is provided for the second request for the intercepted data of target to point it to the data, or portion of data, that has already been intercepted for the target.

If there is no overlap or only a partial overlap between a potential new target or auto target against an existing target per step 858, then the new target or auto target can be provisioned to be intercepted based upon the relationship discovered by the metadata processing unit for the portion of data needed. The provisioning step 860 is implemented by target mediation engine 520, acting as an interface manager, in data mediation engine 502 of FIG. 5 that is coupled via coupling “D” to advanced targeting agent engine 414 of MME and advanced targeting engine 402 of FIG. 4. Subsequently, step 862 intercepts any available data streams on the network that meet the target criteria via to access device, e.g., AMB 302-A1-302-Ap and 302-z1 of FIG. 2. Thereafter flowchart 800-C proceeds to connector “BB,” which leads back to step 830 of FIG. 8B for receiving data for target, e.g., including advanced target, and proceeds in parallel via connector “DD” which leads to FIG. 8E flowchart 800-E of a method for analysis and collection of data.

Referring now to FIG. 8D, a flowchart 800-D, continued via connector “3” from FIG. 8A, of a method of storing and retrieving data on a circular buffer is shown, according to one or more embodiments. Flowchart 800-D embodies the optional third data path function, illustrated in FIG. 1, of storing intercepted data on a circular buffer storage and retrieving the retained intercepted data on the circular buffer storage at a later time. This method allows the convenience of retrieving data from a circular buffer that stores only a given timeframe of data before being overwritten. A system such as this becomes invaluable when needing to look back in time after the occurrence of a serious security breach to retrieve network communication data that is otherwise not interceptable.

Step 870 implements tagging the data streams of targets with a target ID (TID) and a record ID (RID) and tagging the data streams of non-targets that are intercepted from the network, with only a RID, for subsequent storage as retained data. Thus for example, when data streams of a target or non-target are received in access portion of the NSS, MME server 310 can identify targets, and tag or wrap them with the RID and TID, as well as identify non-targets and tag or wrap them with the RID (TID is ZERO), then pass them all to storage buffer 350. Step 836 can optionally perform the tagging portion of this step for the targets.

Step 871 is for storing data on a circular storage device, such as a circular, or storage, buffer 350 of FIG. 3, for future access. Storage of data can be performed according to any protocol, whether storing just a portion of, or a full content of, the data streams intercepted from the network, and whether intercepting a portion of the users of the network or all the users of the network. Thus the present method may store both the content and metadata for both targets and non-targets intercepted from the network, or any other combination desired by a surveillance user or NSS administrator. Step 871 is implemented in FIG. 3 by receiving at a storage buffer 350, the intercepted data from a network via an access device, e.g., as provided by line cards 332-1 thru 332-t and via 1G/10G Ethernet OF 336. Management of the portion of data stored is provided by control lines, not shown, in FIG. 2 that communicate NSS administrator or surveillance user storage preferences to target input block 204 to AMB, e.g., 302-A1, via data mediation engine 502. As shown in FIG. 7B, column “Y” has a “YES” for every row entry in the present embodiment, thus indicating that every data stream, whether target or non-target would be recorded on the circular, or storage, buffer 350. In an optional embodiment, prioritization can be added to given targets and non-targets that have higher likelihood of needing retained data. Thus, in table 700-B of FIG. 7B, rows 702, 708, 711, and 713 have a “YES-1” entry for column “Y” circular buffer, indicating that they have a longer retention time, e.g., overwriting only after a given quantity of cycles, an elapsed time, or a command from an NSS user or the NSS system. The record ID and/or target ID is stored along with the content and/or metadata in the storage buffer 350, so that the stored content and/or metadata may be retrieved at some later point per a request referencing the RID and/or TID.

Step 872 is for overwriting data on the circular buffer, which automatically occurs once the circular buffer capacity has been reached. While the present embodiment utilizes an overwrite protocol that overwrites data continuously on a first-in-first-out (FIFO) basis, the present disclosure is well-suited to a wide range of overwriting algorithms, with optional hierarchical and Pareto sequencing formats for more important data streams, e.g., for suspected but not actual targets. Step 872 is implemented for every AMB device on every network, or on prioritized AMB(s) on prioritized network(s). Thus, a given target may have fragmented data that is distributed across multiple storage buffers on multiple AMB engines.

Step 874 is for retrieving data from circular buffer 874. A request to retrieve data can be provided by an administrator of the NSS, a surveillance user, e.g., a LEA, or by an autoprovisioning request. Once received, circular buffer will seek the oldest data for a requested target or network user. Retained data of either content or metadata can be retrieved from circular buffer via target ID, record ID, or other global search term. Optionally, circular buffer can be programmed to preserve critical data that would otherwise be overwritten, by selectively skipping over the desired data when overwriting new incoming data, either for either a prescribed or an indefinite time period. Additional circular storage buffers may be coupled to the 1G/10G interface so as to preserve the entire record of network communication at the occurrence of a serious security breach. Once requested to be retrieved, retained data can enter into the NSS similar to a real-time intercepted data stream on the first data path per connector “BB” back to FIG. 8B, e.g., via a 10G line card 332-t transmitting via PIMS card 334 of FIG. 3 to data mediation block 502 of FIG. 5, where target mediation block would identify the new or advanced target from LUT 700-A and tag the data stream for subsequent processing, such as processing per flowchart 800-E of a method for analysis and collection of data. Alternatively, if circular buffer is centrally located, then a single request to a single circular buffer will suffice to retrieve any existing data.

Referring now to FIG. 8E, a flowchart, continued via connector “DD” from either FIG. 8B, 8C, or 8D of a method of collecting and analyzing intercepted and processed data is shown, according to one or more embodiments. Step 880 is for receiving processed data at a collection and analysis portion of the NSS. Step 880 is implemented by receiving and buffering on FTP server 604: content and meta data of targets and/or advanced targets from the scalable quantity of data processing engines, e.g., DPUs and DSUs, per FIG. 5 connector “F”; metadata from non-targets, from MME & advanced targeting engine 402 connector “G;” and other relational data and metrics from any combination of first, second, and third data path.

Step 882 is for evaluating relational data between data streams of network users at an analysis system for performing analysis, evaluation, feedback, and/or output to surveillance user interface. Step 882 is implemented via further processing methods including: link charts; dossier collection of metadata and/or content for a given record ID of a non-target or for a given target ID or a given target comprising multiple target IDs; social networking program for interactive processing of metadata or content of a given target or non-target by NSS user with respect to other targets and/or non-targets; relational data analysis between multiple network users, whether targets or non-targets, using content and/or metadata; relationship and a degree of freedom, or degree of separation, graphing or tabulation between a plurality of network users, etc. on analysis tools platforms 608-1 to 608-r.

Step 886 is for displaying the data of the target intercepted on the network on analysis GUI. Optionally, processed or analyzed data may be displayed on GUI for subsequent interface, feedback and instructions from the surveillance user. The analysis GUI is operable to receive commands from an analysis user in order to intercept additional data, query the system, or add notes or other metadata regarding the target or non-target.

Multi-Tenant and Multi-network usage of a single NSS is implemented by tracking and controlling access to targets, non-targets and their data via a surveillance user ID vis-à-vis a target ID and/or record ID, where the surveillance ID specifies the administrative rights and privileges the surveillance user has on the NSS, e.g., to the targets they entered into the NSS or the targets to which they have authority to access. Thus, the present disclosure allows a single NSS to manage multiple independent surveillance users, or LEAs, while still maintaining strict security and confidentiality from other surveillance users. By not requiring a separate surveillance system for each surveillance user, substantial savings in cost and other resources can be realized.

While not illustrated in flowcharts, the methods, apparatus, and system herein can act as a single source to manage targets and non-targets, and their intercepted data for a plurality of surveillance users (multi-tenant). This is accomplished by tracking and controlling access to targets, non-targets and their data via a surveillance user ID vis-à-vis a target ID or record ID, where the surveillance ID specifies the administrative rights and privileges the surveillance user has on the NSS, e.g., to the targets they entered into the NSS or the targets to which they have authority to access. Thus, the present disclosure allows a single NSS to manage multiple independent surveillance users, or LEAs, while still maintaining strict security and confidentiality from other surveillance users. By not requiring a separate surveillance system for each surveillance user, substantial savings in cost and other resources can be realized.

Similarly, the methods, apparatus, and system herein can act as a single source to manage targets and non-targets, and their intercepted data on a plurality of networks (multi-network). This is accomplished by tracking and controlling access to targets, non-targets and their data via a network ID vis-à-vis a target ID, where the network ID can specify features such as data link types, individual network protocols, rules, and other requirements. Thus, the present disclosure allows a single NSS to manage multiple independent networks, can be realized while still maintaining strict security and confidentiality and compliance on a network by network basis. By not requiring a separate surveillance system for each network, substantial savings in cost and other resources can be realized.

A present embodiment of the disclosure utilizes flowcharts in FIGS. 8A-8E to illustrate functions of intercepting, mediating, extracting metadata and analyzing both content and metadata, and storing and retrieving data on a network security system for an analyst that is a government agent, e.g., a LEA seeking information on targets and non-targets exemplified from case tables in FIGS. 7A-7C. However, the present invention is useful for any other type of analyst, e.g., a corporate agent, an educational associate, or any other valid person or entity needing to gather and analyze information of a target or non-target on a communication system, seeking any kind of information, metric, or relationship.

For example, a government agent could include a LEA or other authorized federal, state, or local agent for lawful interception, an intelligence officer for the military or for national defense; or other authorized executive branch or administrative agency, e.g., SEC, DOJ, etc. Similarly, a corporate analyst could be anyone from security to information technology to marketing for monitoring corporate communication systems, e.g., private branch exchange (PBX), intranet, etc. for determining relationships between of targets and/or non-targets, e.g., between employees themselves, between employees and customers, or between employees and other parties. Educational analysts could be any valid educator or student seeking studies on anonymous populations of users, on contractually consenting users, or other broad-based studies such as demographics. Finally, a valid person or entity needing information could include a private citizen performing a missing person or lost relative search.

Any of the above analysts could use the network security system for analyzing content of communications if authorized or if not regulated. Alternatively, any of the above analysts could use the network security system for analyzing metadata of communications, typically without any regulation issues as metadata is not usually regulated.

While fields and metrics utilized in case tables in FIGS. 7A-7C are for targets and non-targets sought by an analyst that is a LEA or other authorized agent for lawful interception, the present invention is also applicable to a wide range of fields and metrics to be sought and tracked for targets and non-targets for other analysts, such as those mentioned above. Some of the fields will not be used, such as warrant and judge information. Other fields and metrics could apply to many different analysts' needs and applications. For example, logistics of the communication such as time, date, location, attachments and names thereof, names of parties, etc. can apply to many different types of analysis. Other fields may be more applicable to a specific analysts needs. For example, finance metrics for corporate security or marketing could include: financial transactions, product purchases, investments, psychological profiles, buying profiles, stock market transactions, consumer behavior, financial credit ratings, etc. Similarly, educational metrics e.g., case studies, etc.; personal and social networking, e.g., personal information and relationships, suggested connections, marketing, etc.; or any other application of content, metadata, and/or relationship metrics. The type of data gathered and analyzed is limited only by the existence of the data in the communications. Data can be used by the analyst for any valid temporal purpose whether for historical, contemporaneous, or a predictive future basis, and for any degree of resolution, whether for individuals, or different sizes of populations, and for factual data as well as stochastic variations and studies.

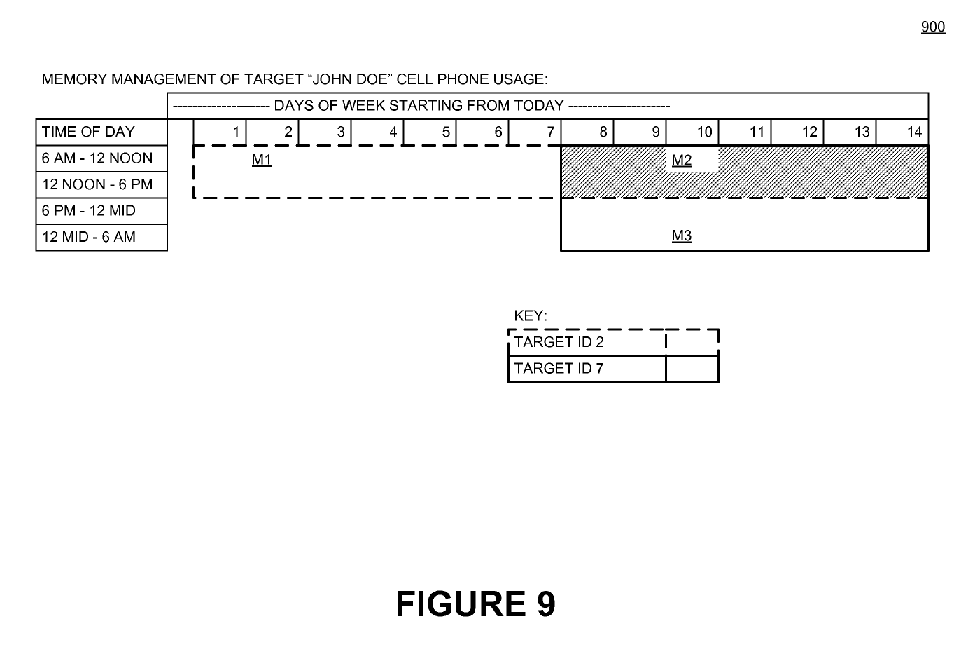

Referring now to FIG. 9, an illustration of partitioned memory for storing content, metadata, and analysis information for targets and non-targets is shown, according to one or more embodiments. Memory block M1 covers data stored for target “John Doe” from day 1 to day 7 from 6 am-6 pm, while block M2 covers data stored for target “John Doe” from day 8 to day 14 from 6 am-6 pm. Block M3 covers data stored for target “John Doe” from 6 pm-6 am from data 8 to day 14. By have a sufficient resolution in the data, and by segregating the stored data in partitions that consider the allowed days, times, target types, etc. for a target, the data can then be stored, and shared among multiple surveillance users and thereby save memory and cost.

Other features of the present embodiments will be apparent from the accompanying drawings and from the detailed description that follows. In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

I/We claim:

1. A method of intercepting data streams, the method comprising:
receiving at a network surveillance system (NSS), a target to be intercepted on a network;
creating a target identification (target ID) for the target, wherein the target ID is unique to the NSS in order to track data streams of the target during subsequent processed in the NSS; and
intercepting the data streams of the target on the network.

2. The method of claim 1 wherein one of the data streams is a data packet associated with the target, wherein the network is the Internet, wherein the network surveillance system is a lawful interception (LI) surveillance network, and wherein the subsequent processing includes extraction of content and metadata from the data packet associated with the target.

3. The method of claim 1 wherein the target ID is unique for a combination of information chosen from a group of data comprising: the target, a target type associated with the target, and relational data associated with the target.

4. The method of claim 1 further comprising:
repeating the receiving, creating, and intercepting processes for a plurality of targets.

5. The method of claim 4 further comprising:
aggregating the targets received at the NSS to determine a superset of data streams to be intercepted.

6. The method of claim 5 further comprising:
provisioning a list of target IDs via a data mediation engine to an access device in order to intercept data streams used by the targets on the network.

7. The method of claim 6 further comprising:
provisioning at least one access device coupled to the network to intercept the data streams used by the targets, wherein the access device is a passive probe or is an active port to a network router.

8. The method of claim 1 further comprising:
tagging the data streams of the target, that are intercepted from the network, with a respective target ID; and
transmitting the data streams of the target to the NSS for subsequent analysis.

9. The method of claim 6 further comprising:
distributing the data streams across a scalable quantity of data processing engines in the NSS.

10. The method of claim 9 further comprising:
evaluating a metadata portion of the data streams using a scalable quantity of data processing units (DPUs).

11. The method of claim 10 further comprising:
storing a content portion of the data streams in a scalable quantity of data storage units (DSUs) coupled to the DPUs.

12. The method of claim 9 further comprising:
receiving data from the scalable quantity of data processing engines at a server; and
transferring the data to an analysis system for interpreting the data.

13. The method of claim 12 further comprising:
evaluating relational data between a plurality of network users of the data streams to identify a relationship and a degree of separation between a plurality of network users.

14. The method of claim 12 further comprising:
displaying on a GUI, the data of the target intercepted on the network.

15. The method of claim 1 further comprising:
storing at least a portion of the data streams intercepted from the network, in a circular storage device for future access.

16. The method of claim 1 further comprising:
evaluating a metadata portion of at least one of the data streams using a metadata processing engine in the NSS.

17. The method of claim 16 further comprising:
evaluating relational data between a metadata portion of a plurality of data streams from a plurality of network users to identify a relationship between at least two of the plurality of data streams.

18. The method of claim 1 further comprising:
identifying an advanced target to intercept based on a relationship between any combination of at least two items from the group consisting of: a first target, a second target, a first non-target, and a second non-target.

19. The method of claim 16 further comprising:
provisioning an advanced target to be intercepted based upon the relationship discovered by the metadata processing unit.

20. The method of claim 19 further comprising:
receiving the advanced target at an interface manager in the NSS; and
evaluating the advanced target for redundancy against existing targets of the NSS.

21. The method of claim 20 further comprising:
communicating the advanced target to either at least one access device on the network or to a circular storage device; and
intercepting data streams associated with the advanced target.

22. The method of claim 1 wherein the target ID can reference fields chosen from a group of data consisting of: a network ID, a requesting agency ID, a network provider ID, a target name, a target handle, an intercept time and an intercept date.

23. The method of claim 1 wherein the NSS is a single source to manage targets and intercepted data for a plurality of surveillance users.

24. The method of claim 1 wherein the NSS is a single source to manage intercepted data received from a plurality of access devices operating on a plurality of networks.

25. The method of claim 1 further comprising:
creating a look up table (LUT) to track the target and the data streams of the target.

26. A network surveillance system comprising:
a graphical user interface (GUI) to receive a target to be intercepted on a network;
a data mediation engine coupled to the GUI, the data mediation engine operative to create a target ID for the target in the network, wherein the target ID is unique to the network surveillance system (NSS) in order to track data streams of the target in subsequent processing by the NSS; and
an access device, coupled to the data mediation engine, for intercepting the data streams of the target on the network.

27. The network surveillance system of claim 26 wherein the data stream is a data packet, wherein the network is the Internet, wherein the network surveillance system is a lawful interception (LI) surveillance network, and wherein the subsequent processing includes extraction of content and metadata from the data packet associated with a target.

28. The network surveillance system of claim 26 further comprising:
a scalable quantity of data processing engines for evaluating data streams intercepted from a network, the scalable quantity of data processing engines allowing the NSS to be scaled to accommodate higher data processing requirements.

29. The network surveillance system of claim 28 wherein the scalable quantity of data processing engines further comprises:
a scalable quantity of data processing units (DPUs) for evaluating a metadata portion of the data streams.

30. The network surveillance system of claim 29 wherein the scalable quantity of data processing engines further comprises: a scalable quantity of data storage units (DSUs) coupled to the DPUs.

31. The network surveillance system of claim 28 further comprising:
a load balancer coupled to the scalable quantity of data processing engines, wherein the load balancer is operative to distribute the data streams to the data processing engines in the network surveillance system for subsequent processing of the data streams.

32. The network surveillance system of claim 27 wherein the load balancer and the data mediation engine track the data streams via the target ID.

33. The network surveillance system of claim 32, wherein a look up table (LUT) is used for matching the data streams of a target with the target ID.

34. The network surveillance system of claim 26 wherein the data mediation engine is further operable to:
receive a list of targets from the GUI; and
provision the list of targets to the access device in order to intercept data streams used by the targets.

35. The network surveillance system of claim 26 wherein the NSS is operable to tag the data streams of the target with a respective target ID.

36. The network surveillance system of claim 26 further comprising:
a server for receiving data from the mediation device and for transferring the information to an analysis system for interpreting the data.

37. The network of claim 26 wherein the access device is a probe coupled to passively intercept, or is an access point to a router to actively intercept, the data streams from the network.

38. The network surveillance system of claim 26, further comprising:
a plurality of access devices coupled to at least one network.

39. The network surveillance system of claim 26 further comprising:
a circular storage device coupled to the access device, wherein the storage device stores at least a portion of the data streams intercepted from the network for future surveillance analysis.

40. The network surveillance system of claim 28 further comprising:
a plurality of graphical user interfaces (GUIs); and
a scalable quantity of load balancers coupled to the scalable quantity of data processing engines.

41. The network surveillance system of claim 26 further comprising:
an analysis system coupled to the data mediation engine, wherein the analysis system is operable to:
evaluate relational data between the data streams intercepted from the network in order to identify a relationship and a degree of separation between the plurality of users; and
output results to the GUI.

42. The network surveillance system of claim 26 further comprising:
a metadata processing engine, coupled to the access device, for evaluating a metadata portion of the data streams.

43. The network surveillance system of claim 42 wherein the metadata processing engine is operable to:
evaluate relational data between a metadata portion of the data streams from a plurality of users to identify a relationship between at least two of the plurality of data streams.

44. The network surveillance system of claim 43 wherein the metadata processing unit is operable to:
request provisioning for an advanced target to be intercepted based upon the relationship discovered by the metadata processing engine.

45. The network surveillance system of claim 44 wherein the data mediation engine is further operable to:
receive a request for provisioning the advanced target;
provisioning the advanced target at the access device in order to intercept data streams used by the advanced target on the network.

46. The network surveillance system of claim 45 wherein the data mediation engine is further operable to:
intercept data streams associated with the advanced target from at least one location chosen from the group including: the network, and a circular storage device.

47. The network surveillance system of claim 26 wherein the target ID can include fields chosen from a group comprising: network ID, requesting agency ID, network provider ID, target name, target handle.

48. The network surveillance system of claim 38 wherein the NSS is a single source to manage intercepted data received from the plurality of access devices operating on a plurality of networks.

49. The network surveillance system of claim 26 wherein the NSS is a single source to manage targets and intercepted data for a plurality of surveillance users.
